(19) United States
(12) Patent Application Publication
(10) Pub. No.: US 2025/0355457 A1
(43) Pub. Date: Nov. 20, 2025

(54) Input Device

(71) Applicant: Alps Alpine Co., Ltd., Tokyo (JP)

(72) Inventors: Kunio HOSONO, Fukushima-ken (JP); Tetsuo MURANAKA, Miyagi-ken (JP)

(21) Appl. No.: 19/185,575

(22) Filed: Apr. 22, 2025

(30) Foreign Application Priority Data
May 17, 2024 (JP) 2024-081345

(51) Int. Cl. G05G 1/015; G01L 1/22; G05G 1/10; G06F 3/0362

(52) U.S. Cl. CPC G05G 1/015; G01L 1/2262; G05G 1/10; G06F 3/0362

(57) ABSTRACT

An input device includes a shaft portion, a deformation portion, a plurality of strain detection elements, and a detection circuit, the detection circuit includes a first measurement circuit including some strain detection elements and detecting a force applied to the shaft portion in a direction orthogonal to the axial direction, a second measurement circuit including other some strain detection elements and detecting a force applied to the shaft portion in the direction, a first fixed resistor connected to a supply voltage of the first measurement circuit, and a second fixed resistor connected to a ground of the second measurement circuit, and the input device detects a force applied to the shaft portion in the axial direction based on a voltage between a connection point of the first measurement circuit and the first fixed resistor and a connection point of the second measurement circuit and the second fixed resistor.

### CLAIM OF PRIORITY

This application claims benefit of Japanese Patent Application No. 2024-081345 filed on May 17, 2024, which is hereby incorporated by reference.

### BACKGROUND OF THE INVENTION

### 1. Field of the Invention

The present disclosure relates to an input device.

### 2. Description of the Related Art

Japanese Unexamined Patent Application Publication No. 2000-047814, regarding an input device, discloses a technique for detecting operations in the X axial direction, the Y axial direction, and the Z axis direction applied to an operation member by detecting the strain of a strain generator with a voltage detection circuit including a bridge circuit including four strain detection elements printed on a flexible substrate and a resistive element connected to the bridge circuit.

In addition, Japanese Unexamined Patent Application Publication No. 2021-177291, regarding input devices, discloses a technique for detecting operations on a lever projection in the X axis direction and the Z axis direction by detecting the strain of a strain generator with a detection circuit including a bridge circuit including four strain detection elements printed on a flexible substrate and a resistive element connected to the bridge circuit. However, in the input device in the related art, in order to increase the output of the detection circuit and detect operations with high sensitivity, it is necessary to greatly distort the strain generator, which ay reduce the durability of the strain generator.

### SUMMARY OF THE INVENTION

An input device according to an embodiment includes an input device includes a shaft portion, a plate-shaped deformation portion integrally formed with the shaft portion and orthogonal to an axial direction of the shaft portion, a plurality of strain detection elements provided on the deformation portion, and a detection circuit, wherein the detection circuit includes a first measurement circuit including some of the plurality of strain detection elements and detecting a force in a direction orthogonal to the axial direction, the force being applied to the shaft portion, a second measurement circuit including other some of the plurality of strain detection elements and detecting a force in a direction orthogonal to the axial direction, the force being applied to the shaft portion, a first fixed resistor connected to a supply voltage of the first measurement circuit, and a second fixed resistor connected to a ground of the second measurement circuit, and wherein the detection circuit detects a force in the axial direction, the force being applied to the shaft portion based on a voltage between a connection point of the first measurement circuit and the first fixed resistor and a connection point of the second measurement circuit and the second fixed resistor.

The input device according to an embodiment can detect the force applied to the shaft portion with high sensitivity without increasing the amount of strain of the strain generator.

### BRIEF DESCRIPTION OF THE DRAWINGS

FIG. 1 is an exploded perspective view of the force sensor according to an embodiment when viewed from above (Z axis positive direction);

FIG. 2 is an exploded perspective view of the force sensor according to an embodiment when viewed from below (Z axis negative direction);

FIG. 3 is a bottom view of the force sensor according to an embodiment;

FIG. 4 is a circuit diagram of the detection circuit of the force sensor according to an embodiment;

FIG. 5 is a circuit diagram showing the first modification of the configuration of the detection circuit of the force sensor according to an embodiment;

FIG. 6 is a circuit diagram showing the second modification of the configuration of the detection circuit of the force sensor according to an embodiment;

FIG. 7 is a circuit diagram showing the third modification of the configuration of the detection circuit of the force sensor according to an embodiment;

FIG. 8 is a circuit diagram showing the fourth modification of the configuration of the detection circuit of the force sensor according to an embodiment;

FIG. 9 shows a first modification of the force sensor according to an embodiment;

FIG. 10 is a circuit diagram showing the fifth modification of the configuration of the detection circuit of the force sensor according to an embodiment;

FIG. 11 is a circuit diagram showing the sixth modification of the configuration of the detection circuit of the force sensor in accordance according to an embodiment;

FIG. 12 is a circuit diagram showing the seventh modification of the configuration of the detection circuit of the force sensor according to an embodiment;

FIG. 13 is a circuit diagram showing the eighth modification of the configuration of the detection circuit of the force sensor according to an embodiment;

FIGS. 14A-14F show a modification of the switch of the force sensor according to an embodiment;

FIG. 15 shows a first modification of the arrangement of a plurality of strain detection elements of the force sensor according to an embodiment;

FIG. 16 shows a second modification of the arrangement of a plurality of strain detection elements of the force sensor according to an embodiment;

FIGS. 17A-17B show a third modification of the arrangement of a plurality of strain detection elements of the force sensor according to an embodiment;

FIG. 18 is a cross-sectional view of the second modification of the force sensor according to an embodiment;

FIG. 19 is a cross-sectional view of the third modification of the force sensor according to an embodiment; and

FIG. 20 is a cross-sectional view of the fourth modification of the force sensor in accordance according to an embodiment.

### DESCRIPTION OF THE PREFERRED EMBODIMENTS

An embodiment is described below. In the following description, for convenience, the X axis direction in the figure is the left-right direction, the Y axis direction in the figure is the front-back direction, and the Z axis direction in the figure is the vertical direction. The X axis positive direction is the right direction, the Y axis positive direction is the forward direction, and the Z axis positive direction is the upward direction. They indicate the relative positional relationship within the device and do not limit the installation direction or the operation direction of the device. All devices with equivalent relative positional relationships within the device including those with the different installation direction or the different operation direction are included in the scope of rights of the present invention.

### Configuration of Force Sensor 100

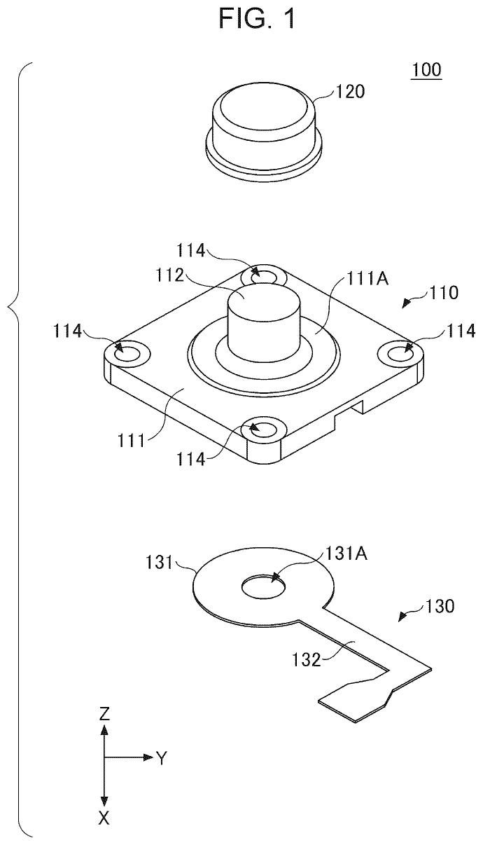

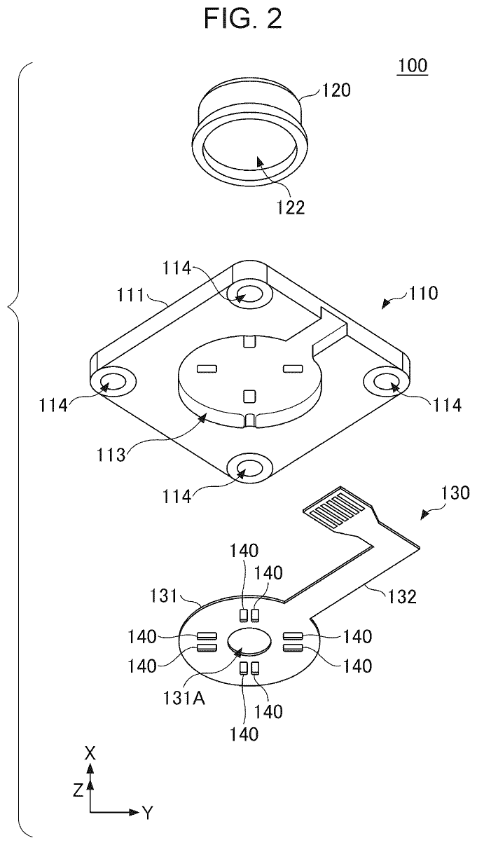

FIG. 1 is an exploded perspective view of a force sensor 100 according to an embodiment when viewed from above (Z axis positive direction). FIG. 2 is an exploded perspective view of the force sensor 100 according to an embodiment when viewed from below (Z axis negative direction).

As shown in FIGS. 1, the force sensor 100 (an example of an “input device”) includes a strain generator 110, an operation knob 120, and a flexible substrate 130.

The strain generator 110 is a plastic material that is distorted when subjected to operational input from the operator. The strain generator 110 includes a base portion 111 and a shaft portion 112.

The base portion 111 is a horizontal, flat plate-like portion with a constant thickness in the vertical (Z axis) direction. The base portion 111 has a square shape in plan view from above and below.

The underside of the base portion 111 has an upwardly recessed recess 113. The recess 113 has a circular shape in plan view from below. A base portion 131 of the flexible substrate 130 is disposed in the recess 113.

The base portion 111 has a circular shaped deformation portion 111A at the center of the topside. The deformation portion 111A is a portion that is distorted by the application of an operation load from the shaft portion 112. The deformation portion 111A has the recess 113 on the back side to be thinner, so that the strain easily occurs.

The four corners of the base portion 111 have four through holes 114 that penetrate the base portion 111 in the vertical direction. The base portion 111 is fixed to any installation surface (not shown) by four fixing screws (not shown) that pass through the four through holes 114.

The shaft portion 112 is a cylindrical portion erected in the center of the deformation portion 111A of the base portion 111 with the vertical (Z axis) direction as its axis direction. The shaft portion 112 is formed integrally with the deformation portion 111A and transfers the operation load applied by the operator to the deformation portion 111A, thereby causing the strain in the deformation portion 111A.

The operation knob 120 is attached to the upper end of the shaft portion 112 of the strain generator 110. Specifically, the operation knob 120 has an upwardly recessed recess 122 in the underside thereof. The recess 122 has a circular shape with a diameter substantially same as that of the upper end of the shaft portion 112 of the strain generator 110 in plan view from below. The operation knob 120 is attached to the upper end of the shaft portion 112 of the strain generator 110 with the upper end of the shaft portion 112 of the strain generator 110 fit into the recess 122. The operation knob 120 receives an operation input from the operator.

The flexible substrate 130 is a flexible film-like wiring component. The flexible substrate 130 includes the base portion 131 and a drawer 132.

The base portion 131 has a circular shape in plan view and is disposed in the recess 113 of the strain generator 110 and is attached to the back face of the deformation portion 111A of the strain generator 110. The base portion 131 has a circular opening 131A at the center thereof.

The drawer 132 is a band-shaped portion extending outward (in the X axis positive direction and the Y axis positive direction) from the outer edge of the base portion 131. The drawer 132 is electrically connected to an external connector (not shown) at its distal end.

In the flexible substrate 130, eight strain detection elements 140 are provided on the underside of the base portion 131 around the opening 131A. Each of the eight strain detection elements 140 is a resistive element printed on the underside of the base portion 131. The eight strain detection elements 140 are provided to detect the strain of the deformation portion 111A of the strain generator 110, the strain being caused by the operator's operational input to the shaft portion 112 of the strain generator 110. The eight strain detection elements 140 are collectively disposed on the back face of the deformation portion 111A with the base portion 131 of the flexible substrate 130 attached to the back face of the deformation portion 111A of the strain generator 110.

The flexible substrate 130 can output strain detection signals (analog signals) representing the strain of the deformation portion 111A of the strain generator 110, the strain being detected by each of the eight strain detection elements 140, to an external computer via the drawer 132.

In the force sensor 100 configured as described above, when an operation (tilting operation and pushing operation) is performed by an operator on the shaft portion 112 of the strain generator 110, a strain occurs in the deformation portion 111A of the strain generator 110, and the strain can be detected by the eight strain detection elements 140 provided on the strain generator 110.

### Arrangement of Strain Detection Element 140

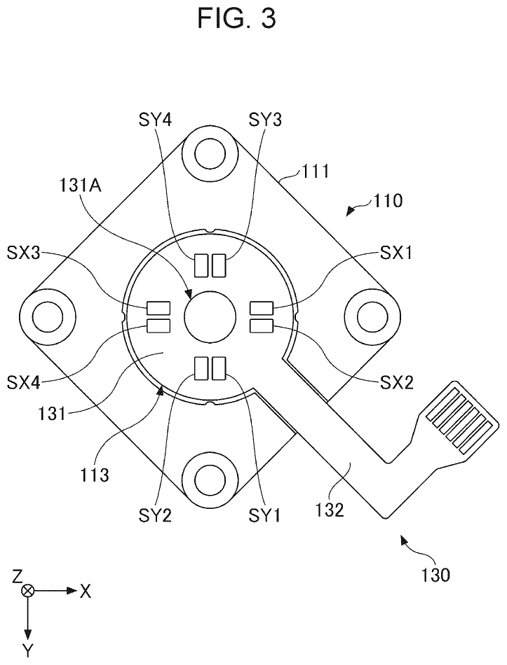

Referring now to FIG. 3, the arrangement of the eight strain detection elements 140 of the force sensor 100 is described. FIG. 3 is a bottom view of the force sensor 100 according to an embodiment.

As shown in FIG. 3, the force sensor 100 has two strain detection elements 140 in each of four directions (forward (Y axis positive direction), backward (Y axis negative direction), right (X axis positive direction), and left (X axis negative direction)) with respect to the opening 131A (for example, the center of the base portion 131) on the underside of the base portion 131 of the flexible substrate 130.

The eight strain detection elements 140 are resistive elements printed on the underside of the base portion 131 of the flexible substrate 130. Each of the eight strain detection elements 140 has a rectangular shape with the detection direction as the longitudinal direction, and is connected to the wiring (not shown) of the flexible substrate 130 at both ends in the longitudinal direction. The eight strain detection elements 140 has an increased resistance value by stretching in the longitudinal direction and a decreased resistance value by contracting in the longitudinal direction as a result of the strain of the deformation portion 111A of the strain generator 110.

Specifically, the strain detection element 140 marked “SX1” (hereinafter referred to as a “strain detection element SX1”) and the strain detection element 140 marked “SX2” (hereinafter referred to as a “strain detection element SX2”) are provided side by side in the Y axis direction so as to be parallel to each other on the underside of the base portion 131 on the right side (X axis positive side) with respect to the opening 131A.

The strain detection element 140 marked “SX3” (hereinafter referred to as a “strain detection element SX3”) and the strain detection element 140 marked “SX4” (hereinafter referred to as a “strain detection element SX4”) are provided side by side in the Y axis direction so as to be parallel to each other on the underside of the base portion 131 on the left side (X axis negative side) with respect to the opening 131A.

The strain detection element 140 marked “SY1” (hereinafter referred to as a “strain detection element SY1”) and the strain detection element 140 marked “SY2” (hereinafter referred to as a “strain detection element SY2”) are provided side by side in the X axis direction so as to be parallel to each other on the underside of the base portion 131 on the front side (Y axis positive side) with respect to the opening 131A.

The strain detection element 140 marked “SY3” (hereinafter referred to as a “strain detection element SY3”) and the strain detection element 140 marked “SY4” (hereinafter referred to as a “strain detection element SY4”) are provided side by side in the X axis direction so as to be parallel to each other on the underside of the base portion 131 on the rear side (Y axis negative side) with respect to the opening 131A.

Each of the eight strain detection elements 140 has a rectangular shape with the longitudinal direction being the detection direction, and is provided in an orientation where the tilt direction of the shaft portion 112 is the detection direction.

In other words, the four strain detection elements 140 provided on the right side (X axis positive side) and the left side (X axis negative side) are provided in an orientation where the X axis direction is the detection direction.

As a result, the four strain detection elements 140 provided on the right side (X axis positive side) and the left side (X axis negative side) have a change in resistance value by stretching or contracting in the X axis direction when the shaft portion 112 is tilted in the X axis direction, and can detect the tilting operation in the X axis direction.

For example, when an operation load is applied to the shaft portion 112 in the X axis positive direction, the force sensor 100 according to an embodiment has a change in resistance value in the +direction by stretching of the two strain detection elements SX1 and SX2 on the X axis positive side, and has a change in resistance value in the −direction by contracting of the two strain detection elements SX3 and SX4 on the X axis negative side.

Conversely, when an operation load is applied to the shaft portion 112 in the X axis negative direction, the force sensor 100 according to an embodiment has a change in resistance value in the −direction by contracting of the two strain detection elements SX1 and SX2 on the X axis positive side, and has a change in resistance value in the +direction by stretching of the two strain detection elements SX3 and SX4 on the X axis negative side.

The four strain detection elements 140 on the front side (Y axis positive side) and the rear side (Y axis negative side) are provided with the Y axis direction as the detection direction.

As a result, the four strain detection elements 140 provided on the front side (Y axis positive side) and the rear side (Y axis negative side) stretch or contract in the Y axis direction and have a change in resistance value when the shaft portion 112 is tilted in the Y axis direction, and can detect the tilting operation in the Y axis detection.

For example, when an operation load is applied to the shaft portion 112 in the Y axis positive direction, the force sensor 100 according to an embodiment has a change in resistance value in the +direction by stretching of the two strain detection elements SY1 and SY2 on the Y axis positive side, and has a change in resistance value in the −direction by contracting of the two strain detection elements SY3 and SY4 on the Y axis negative side.

Conversely, when an operation load is applied in the Y axis negative direction to the shaft portion 112, the force sensor 100 according to an embodiment has a change in resistance value in the −direction by contracting of the two strain detection elements SY1 and SY2 on the Y axis positive side, and has a change in resistance value in the +direction by stretching of the two strain detection elements SY3 and SY4 on the X axis negative side.

For example, when an operation load is applied in the Z axis negative direction to the shaft portion 112, the force sensor 100 according to an embodiment has a change in resistance value in the +direction by stretching of all of the eight strain detection elements 140.

The strain detection element SX1 is an example of a “first X axis strain detection element. The strain detection element SX2 is an example of a “second X axis strain detection element. The strain detection element SX3 is an example of a “third X axis strain detection element. The strain detection element SX4 is an example of a “fourth X axis strain detection element.

The strain detection element SY1 is an example of a “first Y axis strain detection element. The strain detection element SY2 is an example of a “second Y axis strain detection element. The strain detection element SY3 is an example of a “third Y axis strain detection element. The strain detection element SY4 is an example of a “fourth Y axis strain detection element.

### Configuration of Detection Circuit 150

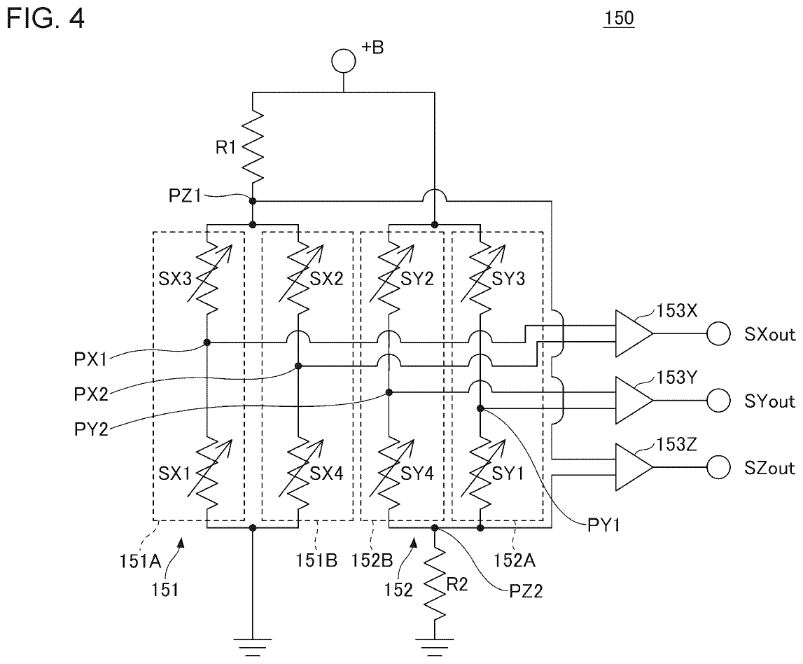

FIG. 4 is a circuit diagram of a detection circuit 150 of the force sensor 100 according to an embodiment.

As shown in FIG. 4, the detection circuit 150 of the force sensor 100 includes a first measurement circuit 151 and a second measurement circuit 152, and each measurement circuit 151, 152 includes the four strain detection elements 140.

The first measurement circuit 151 is a bridge circuit in which a first X axis series circuit 151A in which the strain detection element SX3 and the strain detection element SX1 are connected in series and a second X axis series circuit 151B in which the strain detection element SX2 and the strain detection element SX4 are connected in series are connected in parallel. The strain detection element SX3 and the strain detection element SX2 are provided on the +B side of the supply voltage. On the other hand, the strain detection elements SX1 and SX4 are provided on the ground side.

The first measurement circuit 151 has a first X axis connection point PX1 between the strain detection element SX3 and the strain detection element SX1, and a second X axis connection point PX2 between the strain detection element SX2 and the strain detection element SX4.

The voltage value at the first X axis connection point PX1 and the voltage value at the second X axis connection point PX2 are reversed in polarity.

The second measurement circuit 152 is a bridge circuit in which a first Y axis series circuit 152A in which the strain detection element SY3 and the strain detection element SY1 are connected in series and a second Y axis series circuit 152B in which the strain detection element SY2 and the strain detection element SY4 are connected in series are connected in parallel. The strain detection element SY3 and the strain detection element SY2 are provided on the +B side of the supply voltage. On the other hand, the strain detection elements SY1 and SY4 are provided on the ground side.

The second measurement circuit 152 includes a first Y axis connection point PY1 between the strain detection element SY3 and the strain detection element SY1, and a second Y axis connection point PY2 between the strain detection element SY2 and the strain detection element SY4.

The voltage value at the first Y axis connection point PY1 and the voltage value at the second Y axis connection point PY2 are reversed in polarity.

The detection circuit 150 according to an embodiment detects the force applied to the shaft portion 112 in the X axis direction based on the voltage between the first X axis connection point PX1 and the second X axis connection point PX2. The detection circuit 150 according to an embodiment detects the force applied in the Y axis direction to the shaft portion 112 based on the voltage between the first Y axis connection point PY1 and the second Y axis connection point PY2.

Furthermore, the detection circuit 150 according to an embodiment includes a first fixed resistor R1 connected to the power supply voltage (the constant voltage terminal +B) of the first measurement circuit 151 and a second fixed resistor R2 connected to the ground of the second measurement circuit 152, and detects the force applied to the shaft portion 112 in the Z axis direction based on the voltage between a first Z axis connection point PZ1 between the first measurement circuit 151 and the first fixed resistor R1, and a second Z axis connection point PZ2 between the second measurement circuit 152 and the second fixed resistor R2.

Thus, the detection circuit 150 according to an embodiment includes the four strain detection elements SX1, SX2, SX3, and SX4, which are twice the normal number, for the detection of the operation load in the X axis direction, so that two voltage values of the voltage value output from the first X axis connection point PX1 (the intermediate potential between the strain detection element SX1 and the strain detection element SX2) and the voltage value output from the second X axis connection point PX2 (the intermediate potential between the strain detection element SX3 and the strain detection element SX4) are obtained. Therefore, by measuring the difference between these two voltage values with a differential amplifier 153X, it is possible to obtain the output SXout for the X axis that is twice the output in the related art. Therefore, the detection circuit 150 according to an embodiment can detect the force applied to the shaft portion 112 in the X axis direction with high sensitivity without increasing the amount of strain of the strain generator 110. By doubling the sensitivity, the minimum detectable force is half that of the circuit in the related art. On the other hand, the maximum detectable force is within the range where the strain generator 110 and the strain detection element 140 do not break, and is the same as before. Thus, the dynamic range is double that of the circuit in the related art.

For example, the output SXout for the X axis of the detection circuit 150 according to an embodiment is obtained by the following Expression (1), where k is a constant based on the magnitude of the supply voltage +B and the sensitivity of the strain detection element 140.

$$[ Math 1 ]$$

$$SXout = \frac{SX 1}{SX 1 + SX 3} k - \frac{SX 4}{SX 2 + SX 4} k \qquad ( 1 )$$

Similarly, the detection circuit 150 according to an embodiment includes the four strain detection elements SY1, SY2, SY3, and SY4, which are twice the normal number, for the detection of the operation load in the Y axis direction, so that two voltage values of the voltage value output from the first Y axis connection point PY1 (the intermediate potential between the strain detection element SY1 and the strain detection element SY2) and the voltage value output from the second Y axis connection point PY2 (the intermediate potential between the strain detection element SY3 and the strain detection element SY4) are obtained. Therefore, by measuring the difference between these two voltage values with a differential amplifier 153Y, it is possible to obtain the output SYout for the Y axis that is twice the output in the related art. Therefore, the detection circuit 150 according to an embodiment can detect the force applied to the shaft portion 112 in the Y axis direction with high sensitivity without increasing the amount of strain of the strain generator 110. Doubling the sensitivity halves the minimum detectable force and doubles the dynamic range, compared with that of the circuit in the related art.

For example, the output SYout for the Y axis of the detection circuit 150 according to an embodiment is obtained by the following Expression (2), where k is a constant based on the magnitude of the supply voltage +B and the sensitivity of the strain detection element 140.

$$[ Math 2 ]$$

$$SYout = \frac{SY 1}{SY 1 + SY 3} k - \frac{SY 4}{S X Y + SY 4} k \qquad ( 2 )$$

The detection circuit 150 according to an embodiment makes it possible to obtain, for the detection of the operation load in the Z axis direction, the two voltage values of the voltage value output from the first Z axis connection point PZ1 (the intermediate potential between the first measurement circuit 151 and the first fixed resistor R1) and the voltage value output from the second Z axis connection point PZ2 (the intermediate potential between the second measurement circuit 152 and the second fixed resistor R2), so that by measuring the difference between the two voltage values with a differential amplifier 153Z, it is possible to obtain the output SZout for the Z axis that is twice the output in the related art. Therefore, the detection circuit 150 according to an embodiment can detect the force applied to the shaft portion 112 in the Z axis direction with high sensitivity without increasing the amount of strain of the strain generator 110. Doubling the sensitivity halves the minimum detectable force and doubles the dynamic range, compared with that of the circuit in the related art.

For example, the output SZout for the Z axis of the detection circuit 150 according to an embodiment is obtained by the following Expression (3), where k is a constant based on the magnitude of the supply voltage +B and the sensitivity of the strain detection element 140. BRX indicates a combined resistance of the strain detection elements SX1, SX2, SX3, and SX4 of the first measurement circuit 151. BRY indicates a combined resistance of the strain detection elements SY1, SY2, SY3, and SY4 of the second measurement circuit 152.

$$[ Math 3 ]$$

$$SZout = \frac{R 1}{R 1 + B R X} k - \frac{B R Y}{BRY + R 2} k \qquad ( 3 )$$

The function of the detection circuit 150 is implemented by an integrated circuit (IC), for example. The detection circuit 150 may include an A/D converter at the stage after the differential amplifier 153X, the differential amplifier 153Y, and the differential amplifier 153Z, the A/D converter converting the output SXout for the X axis, the output SYout for the Y axis, and the output SZout for the X axis into digital signals. The grounding may be a potential that can be regarded as a reference potential and may be different from the actual potential of the earth.

### First Modification of Configuration of Detection Circuit 150

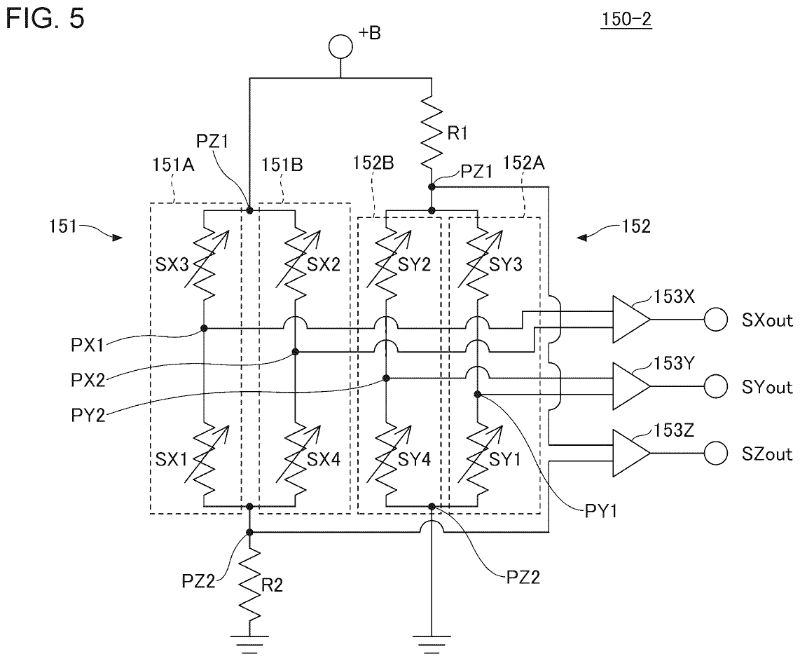

FIG. 5 is a circuit diagram showing the first modification of the configuration of the detection circuit 150 of the force sensor 100 according to an embodiment.

A detection circuit 150-2 shown in FIG. 5 differs from the detection circuit 150 shown in FIG. 4 in that the first fixed resistor R1 is connected to the supply voltage (the constant voltage terminal +B) of the second measurement circuit 152, and the second fixed resistor R2 is connected to the ground of the first measurement circuit 151.

The detection circuit 150-2 shown in FIG. 5 is the same as the detection circuit 150 shown in FIG. 4 in that, for the detection of the operation load in the Z axis direction, two voltage values of the voltage value output from the first Z axis connection point PZ1 (the intermediate potential between the second measurement circuit 152 and the first fixed resistor R1) and the voltage value output from the second Z axis connection point PZ2 (the intermediate potential between the first measurement circuit 151 and the second fixed resistor R2) are obtained.

Therefore, as in the detection circuit 150 shown in FIG. 4, the detection circuit 150-2 shown in FIG. 5 measures the difference between these two voltage values, so that it is possible to obtain the output SZout for the Z axis that is twice the output in the related art.

### Second Modification of Configuration of Detection Circuit 150

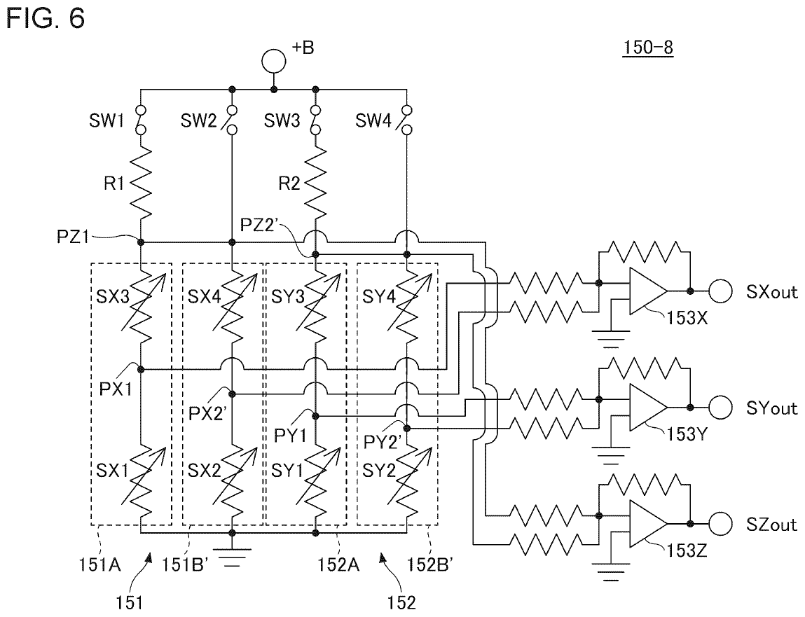

FIG. 6 is a circuit diagram showing the second modification of the configuration of the detection circuit 150 of the force sensor 100 according to an embodiment.

In a detection circuit 150-8 shown in FIG. 6, the first measurement circuit 151 is a bridge circuit in which the first X axis series circuit 151A in which the strain detection element SX3 and the strain detection element SX1 are connected in series and a second X axis series circuit 151B′ in which the strain detection element SX4 and the strain detection element SX2 are connected in series are connected in parallel. The strain detection element SX3 and the strain detection element SX4 are provided on the +B side of the supply voltage. The strain detection element SX1 and the strain detection element SX2 are provided on the ground side. Compared to the detection circuit 150 shown in FIG. 4, the connection relationship between the strain detection element SX2 and the strain detection element SX4, which constitute the second X axis series circuit 151B′, is reversed. In other words, in the detection circuit 150 shown in FIG. 4, the strain detection element SX2 is connected to the supply voltage +B and the strain detection element SX4 is connected to the ground. On the other hand, in the detection circuit 150-8 shown in FIG. 6, the strain detection element SX4 is connected to the supply voltage +B and the strain detection element SX2 is connected to the ground.

In the detection circuit 150-8 shown in FIG. 6, the first measurement circuit 151 includes the first X axis connection point PX1 between the strain detection element SX3 and the strain detection element SX1 and a second X axis connection point PX2′ between the strain detection element SX4 and the strain detection element SX2.

In the detection circuit 150-8 shown in FIG. 6, the second measurement circuit 152 is a bridge circuit in which a first Y axis series circuit 152A in which the strain detection element SY3 and the strain detection element SY1 are connected in series and a second Y axis series circuit 152B′ in which the strain detection element SY4 and the strain detection element SY2 are connected in series are connected in parallel. The strain detection element SY3 and the strain detection element SY4 are provided on the +B side of the supply voltage. The strain detection element SY1 and the strain detection element SY2 are provided on the ground side. Compared to the detection circuit 150 shown in FIG. 4, the connection relationship between the strain detection element SY2 and the strain detection element SY4, which constitute the second Y axis series circuit 152B′, is reversed. In other words, in the detection circuit 150 shown in FIG. 4, the strain detection element SY2 is connected to the supply voltage +B, and the strain detection element SY4 is connected to the ground. On the other hand, in the detection circuit 150-8 shown in FIG. 6, the strain detection element SY4 is connected to the supply voltage +B and the strain detection element SY2 is connected to the ground.

In the detection circuit 150-8 shown in FIG. 6, the second measurement circuit 152 includes the first Y axis connection point PY1 between the strain detection element SY3 and the strain detection element SY1 and a second Y axis connection point PY2′ between the strain detection element SY4 and the strain detection element SY2.

In the detection circuit 150-8 shown in FIG. 6, the voltage value at the first X axis connection point PX1 and the voltage value at the second X axis connection point PX2′ are almost equal. In the detection circuit 150-8 shown in FIG. 6, the voltage value at the first Y axis connection point PY1 and the voltage value at the second Y axis connection point PY2′ are almost equal.

The detection circuit 150-8 shown in FIG. 6 can have two voltage values of the voltage value output from the first X axis connection point PX1 (the intermediate potential between the strain detection element SX1 and the strain detection element SX3) and the voltage value output from the second X axis connection point PX2′ (the intermediate potential between the strain detection element SX2 and the strain detection element SX4). The two voltage values are added together by an addition circuit, so that it is possible to obtain the output SXout for the X axis that is twice the output in the related art.

The output SXout for the X axis of the detection circuit 150 according to the detection circuit 150-8 shown in FIG. 6 is obtained by the following Expression (4), where k is a constant based on the magnitude of the supply voltage +B and the sensitivity of the strain detection element 140. 1 is a constant that is output when no load is applied. For simplification of data processing, an external computer may subtract the constant 1 from Sxout.

$$[ Math 4 ]$$

$$SXout = l - \frac{SX 1}{SX 1 + SX 3} k - \frac{SX 4}{SX 2 + SX 4} k \qquad ( 4 )$$

The detection circuit 150-8 shown in FIG. 6 can have two voltage values of the voltage value output from the first Y axis connection point PY1 (the intermediate potential between the strain detection element SY1 and the strain detection element SY3) and the voltage value output from the second Y axis connection point PY2′ (the intermediate potential between the strain detection element SY2 and the strain detection element SY4). The two voltage values are added together by an addition circuit, so that it is possible to obtain the output SYout for the Y axis that is twice the output in the related art.

The output SYout for the Y axis of the detection circuit 150 according to the detection circuit 150-8 shown in FIG. 6 is obtained by the following Expression (5), where k is a constant based on the magnitude of the supply voltage +B and the sensitivity of the strain detection element 140. 1 is a constant that is output when no load is applied. For simplification of data processing, an external computer may subtract the constant 1 from SXout.

$$[ Math 5 ]$$

$$SYout = l - \frac{SY 1}{SY 1 + SY 3} k - \frac{SY 4}{SY 2 + SY 4} k \qquad ( 5 )$$

Furthermore, the detection circuit 150-8 shown in FIG. 6 includes the first fixed resistor R1 connected to the supply voltage (the constant voltage terminal +B) of the first measurement circuit 151 and the second fixed resistor R2 connected to the supply voltage (the constant voltage terminal +B) of the second measurement circuit 152, and detects the force applied to the shaft portion 112 in the Z axis direction based on the voltage between the first Z axis connection point PZ1 between the first fixed resistor R1 and the first measurement circuit 151 and a second Z axis connection point PZ2′ between the second fixed resistor R2 and the second measurement circuit 152.

The detection circuit 150-8 shown in FIG. 6 makes it possible to obtain, for the detection of the operation load in the Z axis direction, the two voltage values of the voltage value output from the first Z axis connection point PZ1 (the intermediate potential between the first fixed resistor R1 and the first measurement circuit 151) and the voltage value output from the second Z axis connection point PZ2′ (the intermediate potential between the second fixed resistor R2 and the second measurement circuit 152). The two voltage values are added together by an addition circuit, so that it is possible to obtain the output SZout for the Z axis that is twice the output in the related art.

The output SZout for the Z axis of the detection circuit 150 according to the detection circuit 150-8 shown in FIG. 6 is obtained by the following Expression (6), where k is a constant based on the magnitude of the supply voltage +B and the sensitivity of the strain detection element 140. 1 is a constant that is output when no load is applied. For simplification of data processing, an external computer may subtract the constant 1 from SXout.

$$[ Math 6 ]$$

$$SZout = l - \frac{R 1}{R 1 + B R X} k - \frac{B R Y}{BRY + R 2} k \qquad ( 6 )$$

The detection circuit 150-8 shown in FIG. 6 includes a switch SW1 and a switch SW2 between the supply voltage +B and the first measurement circuit 151. The detection circuit 150-8 shown in FIG. 6 includes a switch SW3 and a switch SW4 between the supply voltage +B and the second measurement circuit 152.

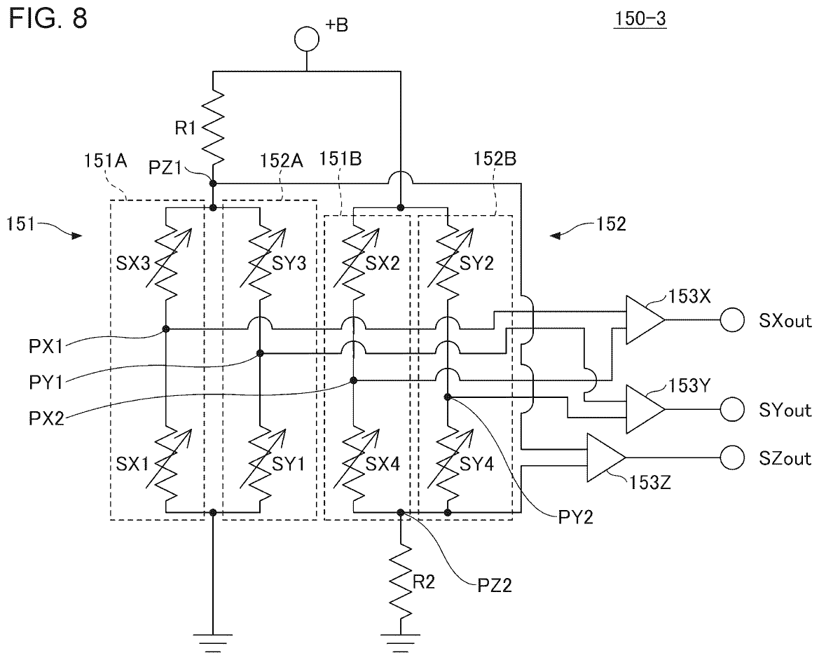

The detection circuit 150-8 shown in FIG. 6 connects the first measurement circuit 151 directly to the supply voltage +B without the first fixed resistor R1 by switching the switch SW1 off and switching the switch SW2 on when detecting X and Y axis operation loads. At the same time, the detection circuit 150-8 shown in FIG. 6 connects the second measurement circuit 152 directly to the supply voltage +B without the second fixed resistor R2 by switching the switch SW3 off and switching the switch SW4 on. As a result, a detection circuit 150-5 shown in FIG. 8 can prevent the detection sensitivity for the X axis and Y axis operation loads from reducing due to the first fixed resistor R1 and the second fixed resistor R2.

The detection circuit 150-8 shown in FIG. 6 connects the first measurement circuit 151 to the supply voltage +B through the first fixed resistor R1 by switching the switch SW1 on and switching the switch SW2 off when detecting the Z axis operation load. At the same time, the detection circuit 150-8 shown in FIG. 6 connects the second measurement circuit 152 to the supply voltage +B through the second fixed resistor R2 by switching the switch SW3 on and switching the switch SW4 off. This allows the detection circuit 150-8 shown in FIG. 6 to detect the Z axis operation load.

### Third Modification of Configuration of Detection Circuit 150

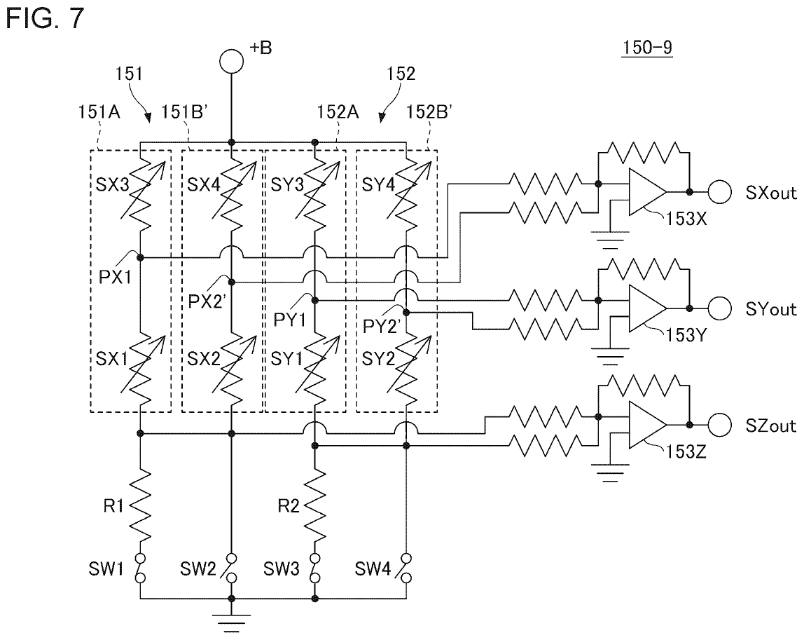

FIG. 7 is a circuit diagram showing the third modification of the configuration of the detection circuit 150 of the force sensor 100 according to an embodiment.

The connection positions of the fixed resistor R1, the fixed resistor R2, the switch SW1, and the switch SW2 are different between the detection circuit 150-8 shown in FIG. 6 and in a detection circuit 150-9 shown in FIG. 7. In the detection circuit 150-9 shown in FIG. 7, a fixed resistor R1 is provided on the ground side of the first measurement circuit 151. Similarly, a fixed resistor R2 is provided on the ground side of the second measurement circuit 152.

The detection circuit 150-9 shown in FIG. 7 includes the switch SW1 and the switch SW2 between the first measurement circuit 151 and the ground. The switch SW3 and the switch SW4 are provided between the second measurement circuit 152 and the ground.

The detection circuit 150-9 shown in FIG. 7 grounds the first measurement circuit 151 without the first fixed resistor R1 by switching the switch SW1 off and switching the switch SW2 when detecting X axis and Y axis operation loads. At the same time, the detection circuit 150-9 shown in FIG. 7 grounds the second measurement circuit 152 without the second fixed resistor R2 by switching the switch SW3 off and switching the switch SW4 on. As a result, the detection circuit 150-9 shown in FIG. 7 can prevent the detection sensitivity for the X axis and Y axis operation loads from reducing due to the first fixed resistor R1 and the second fixed resistor R2.

The detection circuit 150-9 shown in FIG. 7 grounds the first measurement circuit 151 through the first fixed resistor R1 by switching the switch SW1 on and switching the switch SW2 off when detecting an operation load on the Z axis. At the same time, the detection circuit 150-9 shown in FIG. 7 grounds the second measurement circuit 152 through the second fixed resistor R2 by switching the switch SW3 on and switching the switch SW4 off. This allows the detection circuit 150-9 shown in FIG. 7 to detect the Z axis operation load.

### Fourth Modification of Configuration of Detection Circuit 150

FIG. 8 is a circuit diagram showing a fourth modification of the configuration of the detection circuit 150 of the force sensor 100 according to an embodiment.

In a detection circuit 150-3 shown in FIG. 8, the first measurement circuit 151 is a bridge circuit in which the first X axis series circuit 151A in which the strain detection element SX3 and the strain detection element SX1 are connected in series and a first Y axis series circuit 152A in which the strain detection element SY3 and the strain detection element SY1 are connected in series are connected in parallel.

In the detection circuit 150-3 shown in FIG. 8, the first measurement circuit 151 includes the first X axis connection point PX1 between the strain detection element SX3 and the strain detection element SX1 and the first Y axis connection point PY1 between the strain detection element SY3 and the strain detection element SY1.

In the detection circuit 150-3 shown in FIG. 8, the second measurement circuit 152 is a bridge circuit in which the second X axis series circuit 151B in which the strain detection element SX2 and the strain detection element SX4 are connected in series and a second Y axis series circuit 152B in which the strain detection element SY2 and the strain detection element SY4 are connected in series are connected in parallel.

In the detection circuit 150-3 shown in FIG. 8, the second measurement circuit 152 includes the second X axis connection point PX2 between the strain detection element SX2 and the strain detection element SX4 and the second Y axis connection point PY2 between the strain detection element SY4 and the strain detection element SY2.

In the detection circuit 150-3 shown in FIG. 8, the voltage value at the first X axis connection point PX1 and the voltage value at the second X axis connection point PX2 are reversed in polarity. In the detection circuit 150-3 shown in FIG. 8, the voltage value at the first Y axis connection point PY1 and the voltage value at the second Y axis connection point PY2 are reversed in polarity to each other.

As in the detection circuit 150 shown in FIG. 4, the detection circuit 150-3 shown in FIG. 8 makes it possible to obtain the two voltage values of the voltage value output from the first X axis connection point PX1 (the intermediate potential between the strain detection element SX1 and the strain detection element SX2) and the voltage value output from the second X axis connection point PX2 (the intermediate potential between the strain detection element SX3 and the strain detection element SX4), so that by measuring the difference between these two voltage values, it is possible to obtain the output SXout for the X axis that is twice the output in the related art.

As in the detection circuit 150 shown in FIG. 4, the detection circuit 150-3 shown in FIG. 8 makes it possible to obtain the two voltage values of the voltage value output from the first Y axis connection point PY1 (the intermediate potential between the strain detection element SY3 and the strain detection element SY4) and the voltage value output from the second Y axis connection point PY2 (the intermediate potential between the strain detection element SY1 and the strain detection element SY2), so that by measuring the difference between these two voltage values, it is possible to obtain the output SYout for the Y axis that is twice the output in the related art.

As in the detection circuit 150 shown in FIG. 4, the detection circuit 150-3 shown in FIG. 8 makes it possible to obtain the two voltage values of the voltage value output from the first Z axis connection point PZ1 (the intermediate potential between the first measurement circuit 151 and the first fixed resistor R1) and the voltage value output from the second Z axis connection point PZ2 (the intermediate potential between the second measurement circuit 152 and the second fixed resistor R2), so that by measuring the difference between these two voltage values, it is possible to obtain the output SZout for the Z axis that is twice the output in the related art.

### First Modification of Force Sensor 100

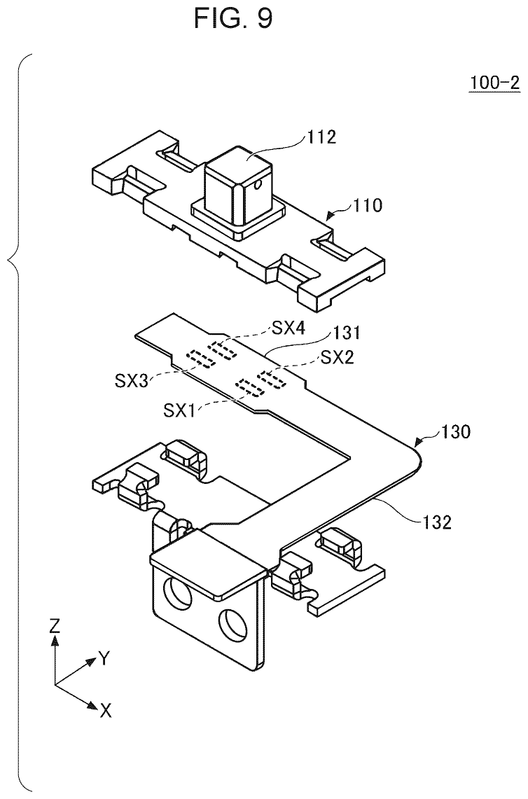

FIG. 9 shows a first modification of the force sensor 100 according to an embodiment. A force sensor 100-2 shown in FIG. 9 is configured to detect the tilting operation in the X axis direction and the pushing operation in the Z axis direction of the shaft portion 112 of the strain generator 110 by the operator. For this reason, the force sensor 100-2 shown in FIG. 9 includes the two strain detection elements 140 in each of the right direction (X axis positive direction) and the left direction (X axis negative direction) on the underside of the base portion 131 of the flexible substrate 130.

Specifically, in the force sensor 100-2 shown in FIG. 9, the strain detection element SX1 and the strain detection element SX2 are provided side by side in the Y axis direction so as to be parallel to each other on the right side (X axis positive side) of the underside of the base portion 131.

In the force sensor 100-2 shown in FIG. 9, the strain detection element SX3 and the strain detection element SX4 are provided side by side in the Y axis direction so as to be parallel to each other on the left side (X axis negative side) of the underside of the base portion 131.

In the force sensor 100-2 shown in FIG. 9, each of the strain detection elements SX1, SX2, SX3, and SX4 has a rectangular shape and is disposed with the long side parallel to the X axis so that the X axis direction is the detection direction.

### Fifth Modification of Configuration of Detection Circuit 150

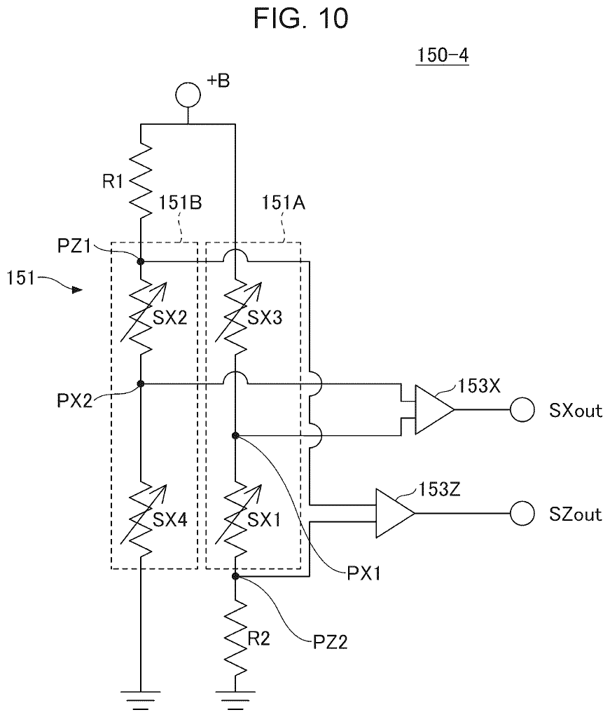

FIG. 10 is a circuit diagram showing the fifth modification of the configuration of the detection circuit 150 of the force sensor 100-2 of FIG. 9.

A detection circuit 150-4 shown in FIG. 10 differs from the detection circuit 150 shown in FIG. 4 in that the detection circuit 150-4 does not have a configuration for detecting the operation load in the Y axis direction. The configuration for detecting the operation load in the X axis direction and the configuration for detecting the operation load in the Z axis direction is the same between the detection circuit 150 shown in FIG. 4 and the detection circuit 150 shown in FIG. 10. For example, the detection circuit 150-4 shown in FIG. 10 is used for the force sensor 100-2 that allows the tilting operation in the X axis direction and the pushing-down operation in the Z axis direction.

Specifically, the detection circuit 150-4 shown in FIG. 10 includes the first measurement circuit 151. The first measurement circuit 151 has a configuration in which the first X axis series circuit 151A in which the strain detection element SX3 and the strain detection element SX1 are connected in series, and the second X axis series circuit 151B in which the strain detection element SX2 and the strain detection element SX4 are connected in series are connected in parallel.

In the detection circuit 150-4 shown in FIG. 10, the first fixed resistor R1 is connected to the supply voltage (the constant voltage terminal +B) of the second X axis series circuit 151B, and the second fixed resistor R2 is connected to the ground of the first X axis series circuit 151A.

As in the detection circuit 150 shown in FIG. 4, the detection circuit 150-4 shown in FIG. 10 makes it possible to obtain the two voltage values of the voltage value output from the first X axis connection point PX1 (the intermediate potential between the strain detection element SX1 and the strain detection element SX3) and the voltage value output from the second X axis connection point PX2 (the intermediate potential between the strain detection element SX2 and the strain detection element SX4), so that by measuring the difference between these two voltage values, it is possible to obtain the output SXout for the X axis that is twice the output in the related art.

The detection circuit 150-4 shown in FIG. 10 makes it possible to obtain the two voltage values of the voltage value output from the first Z axis connection point PZ1 (the intermediate potential between the second X axis series circuit 151B and the first fixed resistor R1) and the voltage value output from the second Z axis connection point PZ2 (the intermediate potential between the first X axis series circuit 151A and the second fixed resistor R2), so that by measuring the difference between these two voltage values, it is possible to obtain the output SZout for the Z axis that is twice the output in the related art.

### Sixth Modification of Configuration of Detection Circuit 150

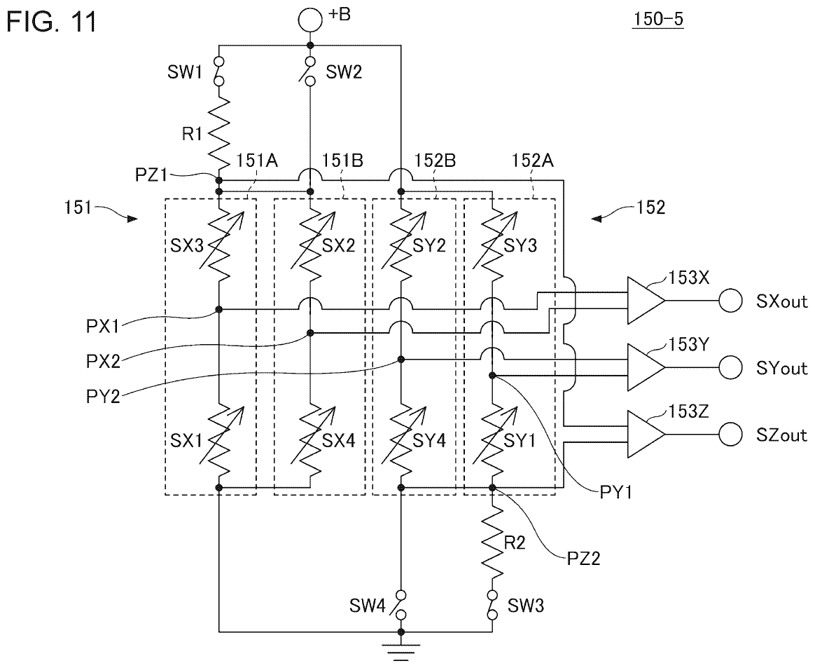

FIG. 11 is a circuit diagram showing the sixth modification of the configuration of the detection circuit 150 of the force sensor 100 according to an embodiment.

The detection circuit 150-5 shown in FIG. 11 differs from the detection circuit 150 shown in FIG. 4 in that the detection circuit 150-5 includes the switch SW1 and the switch SW2 between the first measurement circuit 151 and the supply voltage (the constant voltage terminal +B). The switch SW1 is provided between the first fixed resistor R1 and the supply voltage (the constant voltage terminal +B). In FIG. 11, the switch SW1 is provided between fixed resistor R1 and supply voltage +B. However, the switch SW1 may be provided between the first measurement circuit 151 and the fixed resistor R1.

The detection circuit 150-5 shown in FIG. 11 differs from the detection circuit 150 shown in FIG. 4 in that the detection circuit 150-5 includes the switch SW3 and the switch SW4 between the second measurement circuit 152 and the ground. In FIG. 11, switch SW3 is provided between the second fixed resistor R2 and the ground. However, the switch SW3 may be provided between the second measurement circuit 152 and the fixed resistor R2.

The detection circuit 150-5 shown in FIG. 11 switches SW1, SW2, SW3, and SW4 at high speed in a time-divisional manner.

For example, the detection circuit 150-5 shown in FIG. 11 connects the first measurement circuit 151 directly to the power supply voltage (the constant voltage terminal +B) without the first fixed resistor R1 by switching the switch SW1 off and switching the switch SW2 on when detecting the X axis and Y axis operation loads. At the same time, the detection circuit 150-5 shown in FIG. 11 connects the second measurement circuit 152 directly to the ground without the second fixed resistor R2 by switching the switch SW3 off and switching the switch SW4 on. As a result, the detection circuit 150-5 shown in FIG. 11 can prevent the detection sensitivity for the X axis and Y axis operation loads from reducing due to the first fixed resistor R1 and the second fixed resistor R2.

The detection circuit 150-5 shown in FIG. 11 connects the first measurement circuit 151 to the power supply voltage (the constant voltage terminal +B) via the first fixed resistor R1 by switching the switch SW1 on and switching the switch SW2 off when detecting the Z axis operation load. At the same time, the detection circuit 150-5 shown in FIG. 11 connects the second measurement circuit 152 to the ground through the second fixed resistor R2 by switching the switch SW3 on and switching the switch SW4 off. This allows the detection circuit 150-5 shown in FIG. 11 to detect the Z axis operation load.

### Seventh Modification of Configuration of Detection Circuit 150

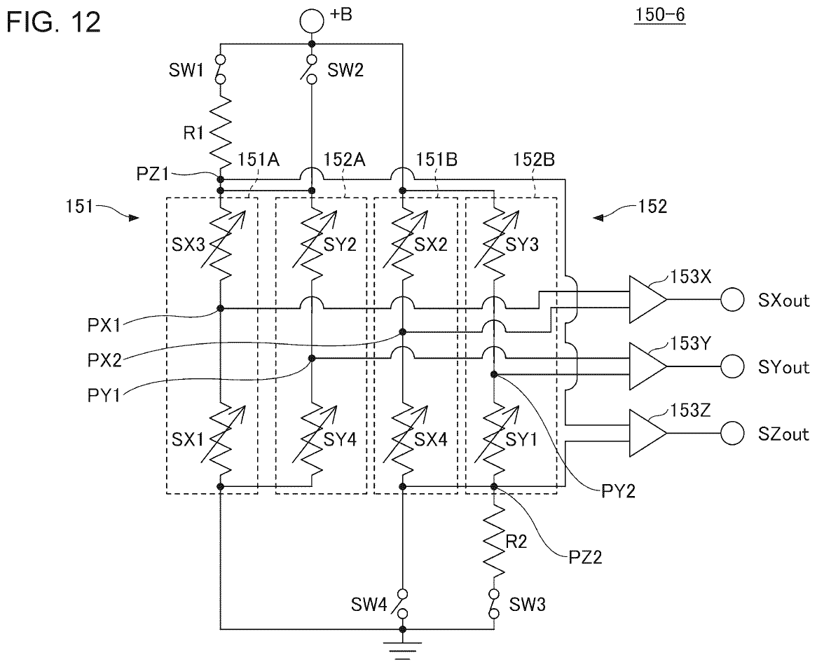

FIG. 12 is a circuit diagram showing the seventh modification of the configuration of the detection circuit 150 of the force sensor 100 according to an embodiment.

A detection circuit 150-6 shown in FIG. 12 differs from the detection circuit 150-3 shown in FIG. 8 in that the detection circuit 150-6 includes the switch SW1 and the switch SW2 between the first measurement circuit 151 and the supply voltage (the constant voltage terminal +B). The switch SW1 is provided between the first fixed resistor R1 and the supply voltage (the constant voltage terminal +B).

The detection circuit 150-6 shown in FIG. 12 differs from the detection circuit 150-3 shown in FIG. 8 in that the detection circuit 150-6 includes the switch SW3 and the switch SW4 between the second measurement circuit 152 and the ground. However, switch SW3 is provided between the second fixed resistor R2 and the ground.

The detection circuit 150-6 shown in FIG. 12 switches SW1, SW2, SW3, and SW4 at high speed in a time-divisional manner.

For example, the detection circuit 150-6 shown in FIG. 12 connects the first measurement circuit 151 directly to the power supply voltage (the constant voltage terminal +B) without the first fixed resistor R1 by switching the switch SW1 off and switching the switch SW2 on when detecting the X axis and Y axis operation loads. At the same time, the detection circuit 150-6 shown in FIG. 12 connects the second measurement circuit 152 directly to the ground without the second fixed resistor R2 by switching the switch SW3 off and switching the switch SW4 on. This allows the detection circuit 150-6 shown in FIG. 12 to suppress power consumption.

The detection circuit 150-6 shown in FIG. 12 connects the first measurement circuit 151 to the power supply voltage (the constant voltage terminal +B) via the first fixed resistor R1 by switching the switch SW1 on and switching the switch SW2 off when detecting the Z axis operation load. At the same time, the detection circuit 150-6 shown in FIG. 12 connects the second measurement circuit 152 to the ground through the second fixed resistor R2 by switching the switch SW3 on and switching the switch SW4 off. This allows the detection circuit 150-6 shown in FIG. 12 to detect the Z axis operation load.

### Eighth Modification of Configuration of Detection Circuit 150

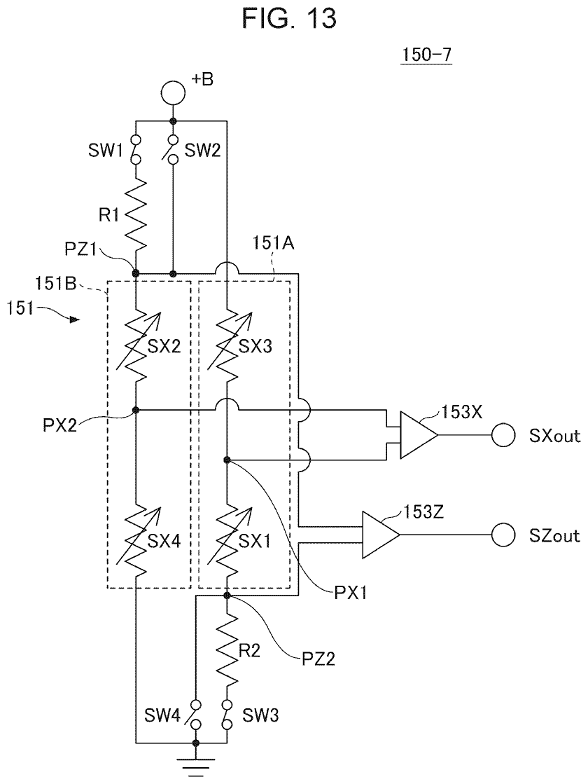

FIG. 13 is a circuit diagram showing the eighth modification of the configuration of the detection circuit 150 of the force sensor 100 according to an embodiment.

A detection circuit 150-7 shown in FIG. 13 differs from the detection circuit 150-4 shown in FIG. 10 in that the detection circuit 150-7 includes the switch SW1 and the switch SW2 between the first measurement circuit 151 and the supply voltage (the constant voltage terminal +B). The switch SW1 is provided between the first fixed resistor R1 and the supply voltage (the constant voltage terminal +B).

The detection circuit 150-7 shown in FIG. 13 differs from the detection circuit 150-4 shown in FIG. 10 in that the detection circuit 150-7 includes the switch SW3 and the switch SW4 between the first measurement circuit 151 and the ground. However, switch SW3 is provided between the second fixed resistor R2 and the ground.

The detection circuit 150-7 shown in FIG. 13 switches SW1, SW2, SW3, and SW4 at high speed in a time-divisional manner.

For example, the detection circuit 150-7 shown in FIG. 13 connects the first measurement circuit 151 directly to the supply voltage (the constant voltage terminal +B) without the first fixed resistor R1 by switching the switch SW1 off and switching the switch SW2 on when detecting an X axis operation load. At the same time, the detection circuit 150-7 shown in FIG. 13 connects the first measurement circuit 151 directly to the ground without the second fixed resistor R2 by switching the switch SW3 off and switching the switch SW4 on. This allows the detection circuit 150-7 shown in FIG. 13 to suppress power consumption.

The detection circuit 150-7 shown in FIG. 13 connects the first measurement circuit 151 to the power supply voltage (the constant voltage terminal +B) via the first fixed resistor R1 by switching the switch SW1 on and switching the switch SW2 off when detecting the Z axis operation load. At the same time, the detection circuit 150-7 shown in FIG. 13 connects the first measurement circuit 151 to the ground through the second fixed resistor R2 by switching the switch SW3 on and switching the switch SW4 off. This allows the detection circuit 150-7 shown in FIG. 13 to detect the Z axis operation load.

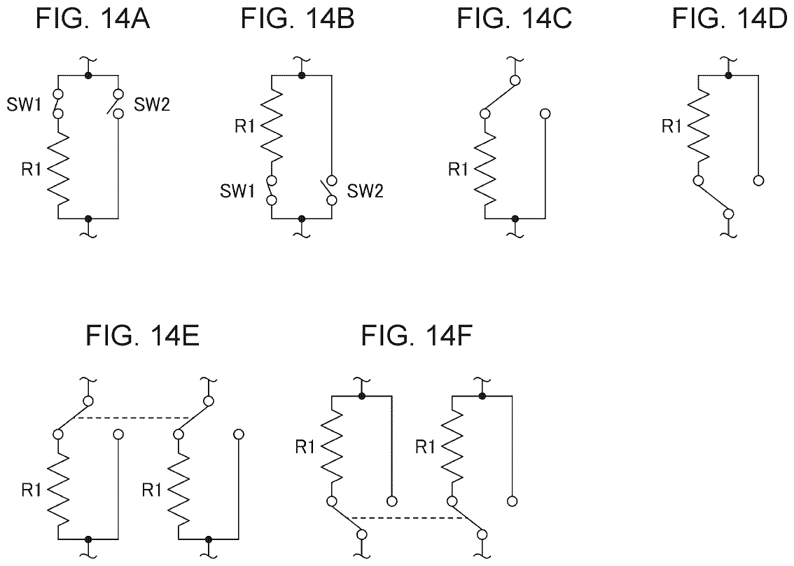

FIGS. 14A-14B show a modification of the switch of the force sensor 100 according to an embodiment.

The switches SW1, SW2, SW3, and SW4 shown in FIGS. 6, 7, and 11 to 13 are implemented, for example, by transistors built into the IC. The connection order of the first fixed resistor R1 and the switch SW1 can be changed. As shown in FIG. 14A, the switch SW1 may be closer to the supply voltage than the first fixed resistor R1. As shown in FIG. 14B, the switch SW1 may be closer to the ground than the fixed resistor R1. Similarly, the connection order of the second fixed resistor R2 and the switch SW3 can be changed. In the detection circuits 150-5 to 150-7 shown in FIGS. 11 to 13, instead of the two switches SW1 and SW2 of SPST type, one switching switch of SPDT type that can switch the connection destination to the first fixed resistor R1 or the first measurement circuit 151 may be provided. Again, the order of connection of the switching switch and the first fixed resistor R1 can be changed. As shown in FIG. 14C, the switching switch may be closer to the supply voltage than the first fixed resistor R1. As shown in FIG. 14D, the switching switch may be closer to the ground than the fixed resistor R1. Similarly, the connection order of the second fixed resistor R2 and the switching switch can be changed. Instead of including two switches in FIG. 14C, the DPDT (bipolar double-throw switch) shown in FIG. 14E) may be included. Similarly, instead of including two switches in FIG. 14D, the DPDT (bipolar double-throw switch) shown in FIG. 14F may be included.

### First Modification of Arrangement of the Plurality of Strain Detection Elements 140

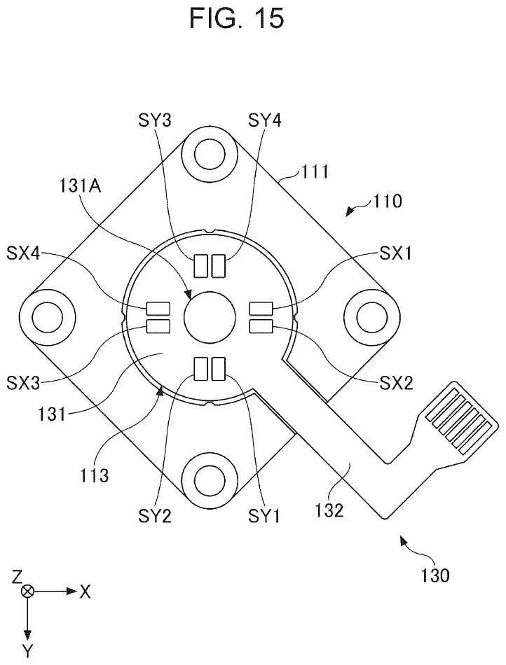

FIG. 15 shows a first modification of the arrangement of the plurality of strain detection elements 140 of the force sensor 100 according to an embodiment.

The configuration in FIG. 15 is different from the configuration in FIG. 3 in that the strain detection element SX3 and the strain detection element SX4 are swapped. In both the configurations in FIG. 15 and FIG. 3, the strain detection element SX3 and the strain detection element SX1 are connected to form the first X axis series circuit 151A. The strain detection element SX2 and the strain detection element SX4 are connected to form the second X axis series circuit 151B. In the configuration shown in FIG. 3, the strain detection element SX3 and the strain detection element SX1 that are located in line-symmetry are connected in series to form the first X axis series circuit 151A. On the other hand, in the configuration shown in FIG. 15, the strain detection element SX3 and the strain detection element SX1 that are located in 180° point symmetry are connected in series to form the first X axis series circuit 151A.

In both the configurations in FIG. 15 and FIG. 3, the strain detection element SX3 and the strain detection element SX4 are provided on the X axis negative side, so that the voltage value at the first X axis connection point PX1 does not change even when the positions of the strain detection element SX3 and the strain detection element SX4 are swapped.

Similarly, in the configuration in FIG. 3, the strain detection element SX2 and the strain detection element SX4 that are located in line-symmetry are connected in series to form the second X axis series circuit 151B. On the other hand, in the configuration shown in FIG. 15, the strain detection element SX4 and the strain detection element SX2 that are located in 180° point symmetry are connected in series to form the second X axis series circuit 151B.

In both the configurations in FIG. 15 and FIG. 3, the strain detection element SX3 and the strain detection element SX4 are provided on the X axis negative side, so that the voltage value at the second X axis connection point PX2 does not change even when the positions of the strain detection element SX3 and the strain detection element SX4 are swapped.

Therefore, the force sensor 100 according to an embodiment measures the difference between the first X axis connection point PX1 and the second X axis connection point PX2 even when the strain detection element SX3 and the strain detection element SX4 are swapped, so that it is possible to obtain the output SXout for the X axis that is twice the output in the related art.

In addition, the configuration in FIG. 15 is different from the configuration in FIG. 3 in that the strain detection element SY3 and the strain detection element SY4 are swapped. In both the configurations in FIG. 15 and FIG. 3, the strain detection element SY3 and the strain detection element SY1 are connected to form the first Y axis series circuit 152A. The strain detection element SY2 and the strain detection element SY4 are connected to form the second Y axis series circuit 152B. In the configuration shown in FIG. 3, the strain detection element SY3 and the strain detection element SY1 that are located in line-symmetry are connected in series to form the first Y axis series circuit 152A. On the other hand, in the arrangement shown in FIG. 15, the strain detection element SY3 and the strain detection element SY1 that are located in 180° point symmetry are connected in series to form the first Y axis series circuit 152A.

In both the configurations in FIG. 15 and FIG. 3, the strain detection element SY3 and the strain detection element SY4 are provided on the Y axis negative side, so the voltage value at the first Y axis connection point PY1 does not change even when the positions of the strain detection element SY3 and the strain detection element SY4 are swapped.

Similarly, in the configuration in FIG. 3, the strain detection element SY2 and the strain detection element SY4 that are located in line-symmetry are connected in series to form the second Y axis series circuit 152B. On the other hand, in the configuration shown in FIG. 15, the strain detection element SY2 and the strain detection element SY4 that are located in 180° point symmetry are connected in series to form the second Y axis series circuit 152B.

In both the configurations in FIG. 15 and FIG. 3, the strain detection element SY3 and the strain detection element SY4 are provided on the Y axis negative side, so that the voltage value at the second Y axis connection point PY2 does not change even when the positions of the strain detection element SY3 and the strain detection element SY4 are swapped.

Therefore, the force sensor 100 according to an embodiment measures the difference between the first Y axis connection point PY1 and the second Y axis connection point PY2 even when the strain detection element SY3 and the strain detection element SY4 are swapped, so that it is possible to obtain the output SYout for the Y axis that is twice the output in the related art.

### Second Modification of Arrangement of the Plurality of Strain Detection Elements 140

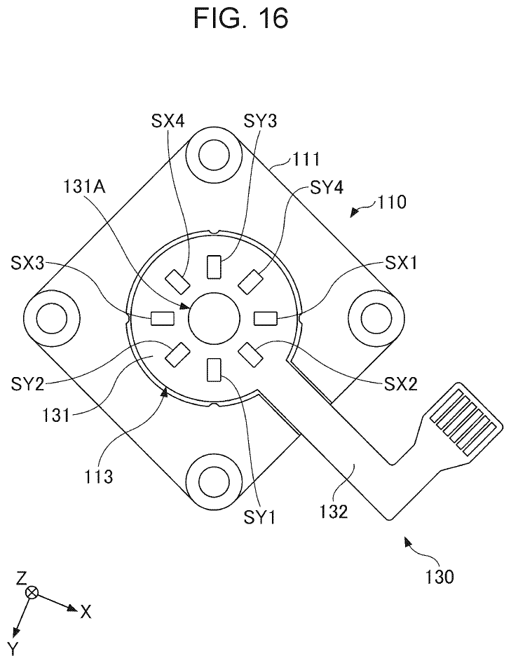

FIG. 16 shows a second modification of the arrangement of the plurality of strain detection elements 140 in the force sensor 100 according to an embodiment.

As shown in FIG. 16, the force sensor 100 according to an embodiment may include eight strain detection elements 140 radially on the underside of the base portion 131 of the flexible substrate 130. In other words, two strain detection elements 140 are paired a intervals and equal angles for the four directions (front, back, left, right). Then, four pairs (eight in total) of strain detection elements 140 corresponding to the four directions (front, back, left, right) may be provided.

For example, in the example shown in FIG. 16, the direction between SX1 and SX2 is the positive direction of the X axis. The direction between SX3 and SX4 is the negative direction of the X axis. The direction between SY1 and SY2 is the positive direction of the Y axis. The direction between SY3 and SY4 is the negative direction of the Y axis. In the example shown in FIG. 16, the eight strain detection elements 140 are provided radially at equal intervals (for example, 45° intervals).

### Third Modification of Arrangement of the Plurality of Strain Detection Elements 140

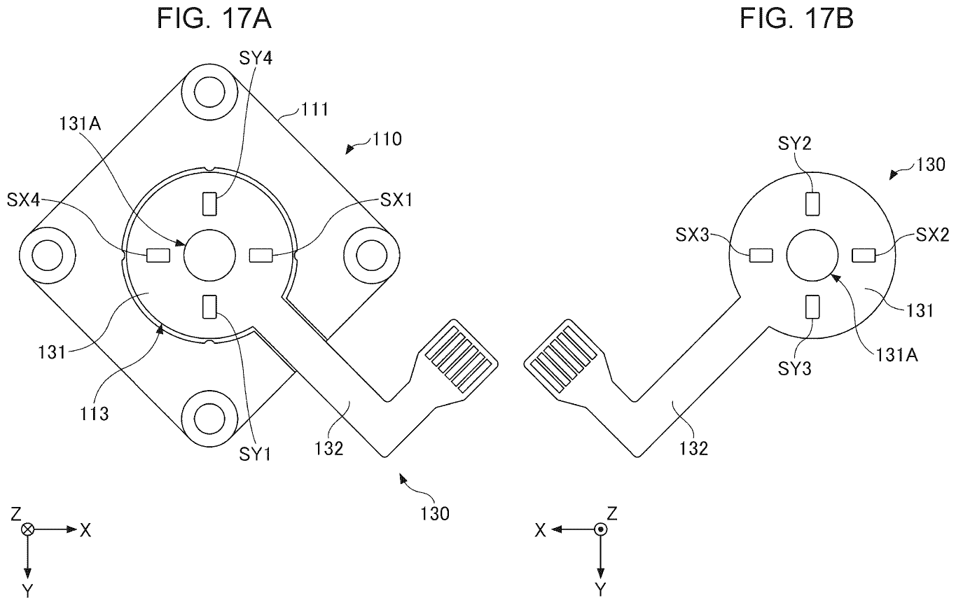

FIGS. 17A-17B show a third modification of the arrangement of the plurality of strain detection elements 140 in the force sensor 100 according to an embodiment.

As shown in FIGS. 17A-17B, the force sensor 100 according to an embodiment may include four strain detection elements 140 corresponding to four directions on the topside of the base portion 131 of the flexible substrate 130 and four strain detection elements 140 corresponding to four directions on the underside of the base portion 131 of the flexible substrate 130. In this case, the four strain detection elements 140 on the topside of the base portion 131 and the four strain detection elements 140 on the underside of the base portion 131 may be disposed to overlap each other. This allows the two strain detection elements 140, which overlap each other, to be equally deformed (contracted or stretched).

For example, as shown in FIG. 17A, the strain detection element SX1, the strain detection element SX4, the strain detection element SY1, and the strain detection element SY4 are provided on the underside of the flexible substrate 130 in the X axis positive direction, in the X axis negative direction, in the Y axis positive direction, and in the Y axis negative direction, respectively. As shown in FIG. 17B, the strain detection element SX2, the strain detection element SX3, the strain detection element SY2, and the strain detection element SY3 are provided on the topside of the flexible substrate 130 in the X axis negative direction, in the X axis positive direction, in the Y axis negative direction, and in the Y axis positive direction, respectively.

In the example shown in FIGS. 17A-17B, the strain detection element SX1 on the topside of the base portion 131 on the X axis positive side and the strain detection element SX3 on the underside of the base portion 131 on the X axis positive side are disposed to overlap each other.

In the example shown in FIGS. 17A-17B, the strain detection element SX2 on the topside of the base portion 131 on the X axis negative side and the strain detection element SX4 on the underside of the base portion 131 on the X axis negative side are disposed to overlap each other.

In the example shown in FIGS. 17A-17B, the strain detection element SY2 on the topside of the base portion 131 on the Y axis positive side and the strain detection element SY4 on the underside of the base portion 131 on the Y axis positive side are disposed to overlap each other.

In the example shown in FIGS. 17A-17B, the strain detection element SY1 on the topside of the base portion 131 on the Y axis negative side and the strain detection element SY3 on the underside of the base portion 131 on the Y axis negative side are disposed to overlap each other.

When an operation load is applied in the X axis positive direction, SX1 and SX2 are stretched, and the resistance value changes in the +direction. On the other hand, when an operation load is applied in the X axis positive direction, SX3 and SX4 contract, and the resistor changes in the −direction.

Conversely, when an operation load is applied in the X axis negative direction, SX1 and SX2 contract, and the resistance value changes in the −direction. On the other hand, when an operation load is applied in the X axis negative direction, SX3 and SX4 are stretched, and the resistance value changes in the +direction.

When an operation load is applied in the Y axis positive direction, SY1 and SY2 are stretched, and the resistance value changes in the +direction. On the other hand, when an operation load is applied in the Y axis positive direction, SY3 and SY4 contract, and the resistance value changes in the −direction.

Conversely, when an operation load is applied in the Y axis negative direction, SY1 and SY2 contract, and the resistance value changes in the −direction. On the other hand, when an operation load is applied in the Y-negative positive direction, SY3 and SY4 are stretched, and the resistance value changes in the +direction.

In the example shown in FIGS. 17A-17B, when an operation load is applied in the negative direction of the Z axis, SX1, SX4, SY1, and SY4 are stretched, and the resistance value changes in the +direction. On the other hand, when an operation load is applied in the Z axis positive direction, SX2, SX3, SY2, and SY3 contract, and the resistance value changes in the −direction. Therefore, SZout measures the load in the Z direction based on SX1, SX4, SY1, SY4, R1, R2 (or SX2, SX3, SY2, SY3, R1, R2).

### Second to Fourth Modifications of Force Sensor 100

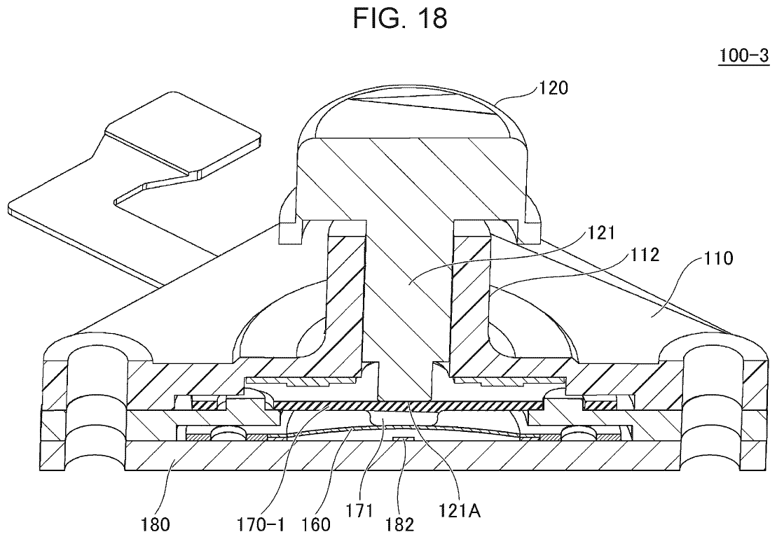

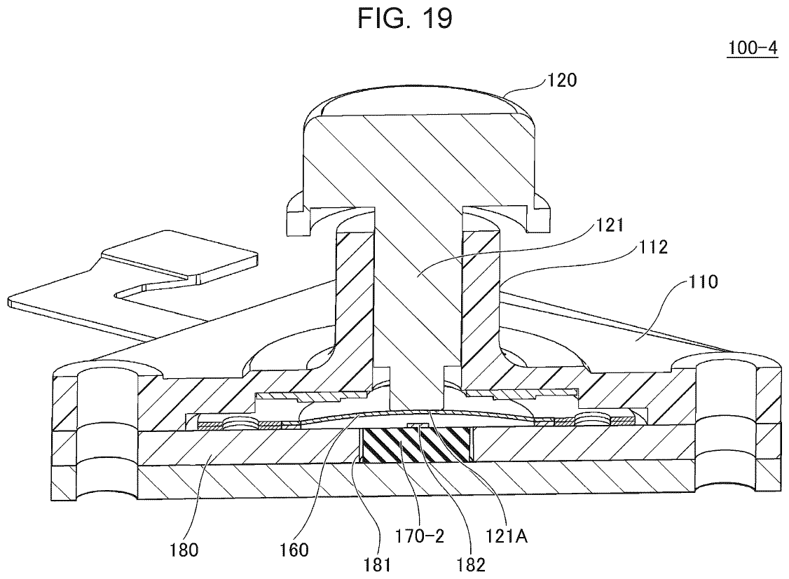

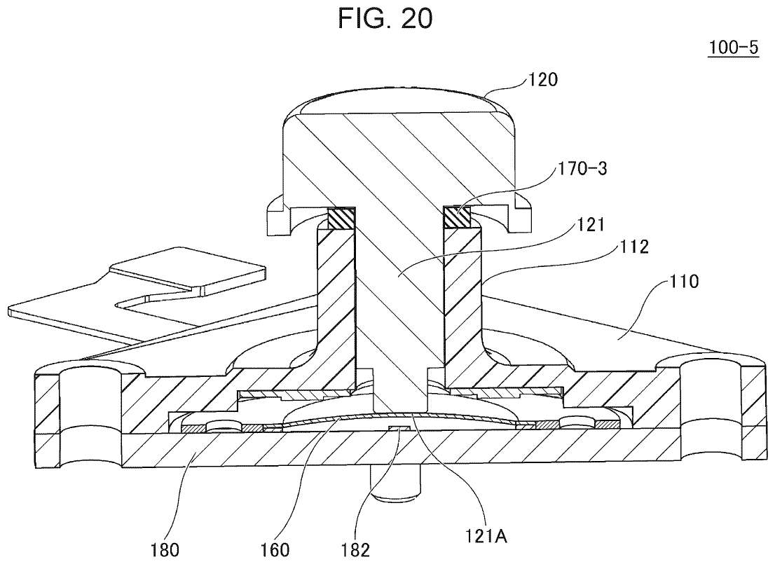

FIG. 18 is a cross-sectional view of the second modification of the force sensor 100 according to an embodiment. FIG. 19 is a cross-sectional view of the third modification of the force sensor 100 according to an embodiment. FIG. 20 is a cross-sectional view of the fourth modification of the force sensor 100 of an embodiment.

The structure of each of force sensors 100-3 to 100-5 shown in FIGS. 18 to 20 is the same as that of the force sensor 100 in that the strain occurring in the deformation portion 111A of the strain generator 110 by the tilting operation by the operator is detected by the eight strain detection elements 140 provided on the strain generator 110.

On the other hand, in each of the force sensors 100-3 to 100-5 shown in FIGS. 18 to 20, the strain generator 110 is superimposed on a substrate 180. Each of the force sensors 100-3 to 100-5 shown in FIGS. 18 to 20 is configured so that a shaft portion 121 extending downward from the underside of the operation knob 120 passes through the shaft portion 112 of the strain generator 110 in the vertical direction. In addition, a metallic and dome-shaped movable contact member 160 is provided facing a lower end face 121A of the shaft portion 121 of the operation knob 120.

In the force sensors 100-3 to 100-5 shown in FIGS. 18 to 20, when the operation knob 120 is pressed down by the operator, the lower end face 121A of the shaft portion 121 of the operation knob 120 presses the top (center) of the movable contact member 160 to move the movable contact member 160 reversely from a convex shape to a concave shape.

As a result, each of the force sensors 100-3 to 100-5 shown in FIGS. 18 to 20 can present a clicking sensation for the pushing-down operation by the operator and bring the center of the movable contact member 160 into contact with a fixed contact 182, and switch the switch including the movable contact member 160 and the fixed contact 182 to the ON state to detect the pushing-down operation by the operator.

Here, in the force sensor 100-3 shown in FIG. 18 includes a horizontal flat elastic member 170-1 made of an elastic material (for example, rubber, silicone, etc.) between the lower end face 121A of the shaft portion 121 of the operation knob 120 and the top of the movable contact member 160. As a result, the force sensor 100-3 shown in FIG. 18 can absorb the contact noise from the lower end face 121A of the shaft portion 121 of the operation knob 120 and the top of the movable contact member 160 by the elastic member 170-1 between the lower end face 121A of the shaft portion 121 of the operation knob 120 and the top of the movable contact member 160, and suppress the contact noise.

In the example shown in FIG. 18, a convex portion 171 is provided on the underside of the elastic member 170-1 to ensure that the top of the movable contact member 160 can be pressed by the convex portion 171.

The force sensor 100-4 shown in FIG. 19 includes a block-shaped elastic member 170-2 made of an elastic material (for example, rubber, silicone, etc.) under the center of the movable contact member 160 (in a recess 181 of the substrate 180). As a result, the force sensor 100-4 shown in FIG. 19 can absorb the contact noise from the movable contact member 160 and the substrate 180 due to the reversal movement of the movable contact member 160 by the elastic member 170-2 at the lower side of the center part of the movable contact member 160, and suppress the contact noise. Furthermore, the force sensor 100-4 shown in FIG. 19 can dampen the movement speed of the shaft portion 121 of the operation knob 120 by the elastic member 170-2, and as a result, the contact noise from the lower end face 121A of the shaft portion 121 of the operation knob 120 and the top of the movable contact member 160 can be suppressed.

The force sensor 100-5 shown in FIG. 20 includes a circular elastic member 170-3 made of an elastic material (for example, rubber, silicone, etc.) between the underside of the operation knob 120 and the topside of the shaft portion 121 of the operation knob 120 so that the circular elastic member 170-3 surrounds the shaft portion 121 of the operation knob 120. As a result, the force sensor 100-5 shown in FIG. 20 can absorb the contact noise from the underside of the operation knob 120 and the topside of the shaft portion 121 of the operation knob 120 by the elastic member 170-3 between the underside of the operation knob 120 and the topside of the shaft portion 121 of the operation knob 120 to suppress the contact noise.

Although an embodiment of the present invention is described in detail above, the present invention is not limited to the embodiment, and various modifications or changes are possible within the scope of the gist of the present invention as described in the claims.

For example, in each of the above detection circuits, the configuration (for example, the first fixed resistor R1, the second fixed resistor R2, the differential amplifier 153Z, etc.) for detecting the operation load in the Z axis direction applied to the shaft portion 112 may not be provided.

What is claimed is:

1. An input device comprising:
a shaft portion;
a plate-shaped deformation portion integrally formed with the shaft portion and orthogonal to an axial direction of the shaft portion;
a plurality of strain detection elements provided on the deformation portion; and
a detection circuit, wherein
the detection circuit includes
a first measurement circuit including some of the plurality of strain detection elements and detecting a force in a direction orthogonal to the axial direction, the force being applied to the shaft portion,
a second measurement circuit including other some of the plurality of strain detection elements and detecting a force in a direction orthogonal to the axial direction, the force being applied to the shaft portion,
a first fixed resistor connected to a supply voltage of the first measurement circuit, and
a second fixed resistor connected to a ground of the second measurement circuit, and wherein
the detection circuit detects a force in the axial direction, the force being applied to the shaft portion based on a voltage between a connection point of the first measurement circuit and the first fixed resistor and a connection point of the second measurement circuit and the second fixed resistor.

2. The input device according to claim 1, wherein
the plurality of strain detection elements includes
a first X axis strain detection element and a second X axis strain detection element provided on a positive side of an X axis orthogonal to the axial direction,
a third X axis strain detection element and a fourth X axis strain detection element provided on a negative side of the X axis,
a first Y axis strain detection element and a second Y axis strain detection element provided on a positive side of the Y axis orthogonal to the axial direction and the X axis, and
a third Y axis strain detection element and a fourth Y axis strain detection element provided on a negative side of the Y axis, wherein
the first measurement circuit
is a bridge circuit in which a first X axis series circuit in which the first X axis strain detection element and the third X axis strain detection element are connected in series, and a second X axis series circuit in which the second X axis strain detection element and the fourth X axis strain detection element are connected in series are connected in parallel,
the first X axis strain detection element and the fourth X axis strain detection element being provided on a ground side,
the second X axis strain detection element and the third X axis strain detection element being provided on a supply voltage side,
the first measurement circuit including a first X axis connection point between the first X axis strain detection element and the third X axis strain detection element, and a second X axis connection point between the second X axis strain detection element and the fourth X axis strain detection element, wherein
the second measurement circuit
is a bridge circuit in which a first Y axis series circuit in which the first Y axis strain detection element and the third Y axis strain detection elements are connected in series, and a second Y axis series circuit in which the second Y axis strain detection element and the fourth Y axis strain detection element are connected in series are connected in parallel,
the first Y axis strain detection element and the fourth Y axis strain detection element being provided on a ground side,
the second Y axis strain detection element and the third Y axis strain detection element being provided on a supply voltage side,
the second measurement circuit including a first Y axis connection point between the first Y axis strain detection element and the third Y axis strain detection element and a second Y axis connection point between the second Y axis strain detection element and the fourth Y axis strain detection element, and wherein
the detection circuit
detects a force applied in a direction of the X axis based on a voltage between the first X axis connection point and the second X axis connection point, and
detects a force applied in a direction of the Y axis based on a voltage between the first Y axis connection point and the second Y axis connection point.

3. The input device according to claim 1, wherein
the plurality of strain detection elements includes
a first X axis strain detection element and a second X axis strain detection element provided on a positive side of an X axis orthogonal to the axial direction,
a third X axis strain detection element and a fourth X axis strain detection element provided on a negative side of the X axis,
a first Y axis strain detection element and a second Y axis strain detection element provided on a positive side of a Y axis orthogonal to the axial direction and the X axis, and
a third Y axis strain detection element and a fourth Y axis strain detection element provided on a negative side of the Y axis, wherein
the first measurement circuit
is a bridge circuit in which a first X axis series circuit in which the first X axis strain detection element and the third X axis strain detection element are connected in series, and a first Y axis series circuit in which the third Y axis strain detection element and the first Y axis strain detection element are connected in series are connected in parallel,
the first measurement circuit including a first X axis connection point between the first X axis strain detection element and the third X axis strain detection element, and a first Y axis connection point between the third Y axis strain detection element and the first Y axis strain detection element, wherein
the second measurement circuit
is a bridge circuit in which a second X axis series circuit in which the second X axis strain detection element and the fourth X axis strain detection element are connected in series, and a second Y axis series circuit in which the second Y axis strain detection element and the fourth Y axis strain detection element are connected in series are connected in parallel,
the second measurement circuit including a second X axis connection point between the second X axis strain detection element and the fourth X axis strain detection element, and a second Y axis connection point between the second Y axis strain detection element and the fourth Y axis strain detection element,
the first X axis strain detection element and the fourth X axis strain detection element being provided on a grounding side,
the second X axis strain detection element and the third X axis strain detection element being provided on a power supply voltage side,
the first Y axis strain detection element and the fourth Y axis strain detection element being provided on a grounding side,
the second Y axis strain detection element and the third Y axis strain detection element being provided on a power supply voltage side, and wherein
the detection circuit
detects a force applied in a direction of the X axis based on a voltage between the first X axis connection point and the second X axis connection point, and
detects a force applied in a direction of the Y axis based on a voltage between the first Y axis connection point and the second Y axis connection point.

4. The input device according to claim 1, wherein
the plurality of strain detection elements includes
a first X axis strain detection element and a second X axis strain detection element provided on a positive side of an X axis orthogonal to the axial direction, and
a third X axis strain detection element and a fourth X axis strain detection element provided on a negative side of the X axis, wherein
the first measurement circuit is a first X axis series circuit in which a third X axis strain detection element and a first X axis strain detection element are connected in series, wherein
the second measurement circuit is a second X axis series circuit in which a second X axis strain detection element and a fourth X axis strain detection element are connected in series,
the first X axis strain detection element and the fourth X axis strain detection element being provided on a ground side,
the second X axis strain detection element and the third X axis strain detection element being provided on a supply voltage side, and wherein
the input device includes a first X axis connection point between the first X axis strain detection element and the third X axis strain detection element and a second X axis connection point between the second X axis strain detection element and the fourth X axis strain detection element, and
detects a force applied in a direction of the X axis based on a voltage between the first X axis connection point and the second X axis connection point.

5. The input device according to claim 1, wherein
when detecting a force applied to the shaft portion in a direction orthogonal to the axial direction, the detection circuit connects the supply voltage and the first measurement circuit via the first fixed resistor and grounds the second measurement circuit via the second fixed resistor, and
when detecting a force applied to the shaft portion in the axial direction, the detection circuit directly connects the power supply voltage to the first measurement circuit and directly grounds the second measurement circuit.

6. An input device comprising:
a shaft portion;
a plate-shaped deformation portion integrally formed with the shaft portion and orthogonal to an axial direction of the shaft portion;
a plurality of strain detection elements provided on the deformation portion; and
a detection circuit, wherein
the detection circuit includes
a first measurement circuit that includes some of the plurality of strain detection elements and detects a force applied to the shaft portion in a direction orthogonal to the axial direction,
a second measurement circuit that includes other some of the strain detection elements and detects a force applied to the shaft portion in a direction orthogonal to the axial direction,
a first fixed resistor connected to a supply voltage or a ground of the first measurement circuit and
a second fixed resistor connected to a supply voltage or a ground of the second measurement circuit,
when the first fixed resistor is connected to a supply voltage of the first measurement circuit,
the second fixed resistor being connected to the supply voltage of the second measurement circuit,
when the first fixed resistor is connected to a ground of the first measurement circuit,
the second fixed resistor being connected to the ground of the second measurement circuit, and wherein
the detection circuit detects a force applied to the shaft portion in the axial direction by adding a voltage at a connection point between the first measurement circuit and the first fixed resistor to a voltage at a connection point between the second measurement circuit and the second fixed resistor.

7. The input device according to claim 6, wherein
the plurality of strain detection elements includes
a first X axis strain detection element and a second X axis strain detection element provided on a positive side of an X axis orthogonal to the axial direction,
a third X axis strain detection element and a fourth X axis strain detection element provided on a negative side of the X axis,
a first Y axis strain detection element and a second Y axis strain detection element provided on a positive side of the Y axis orthogonal to the axial direction and the X axis, and
a third Y axis strain detection element and a fourth Y axis strain detection element provided on a negative side of the Y axis, wherein
the first measurement circuit
is a bridge circuit in which a first X axis series circuit in which the first X axis strain detection element and the third X axis strain detection element are connected in series, and a second X axis series circuit in which the second X axis strain detection element and the fourth X axis strain detection element are connected in series are connected in parallel,
the first X axis strain detection element and the second X axis strain detection element being provided on a ground side,
the third X axis strain detection element and the fourth X axis strain detection element being provided on a supply voltage side,
the first measurement circuit including a first X axis connection point between the first X axis strain detection element and the third X axis strain detection element, and a second X axis connection point between the second X axis strain detection element and the fourth X axis strain detection element, wherein
the second measurement circuit
is a bridge circuit in which a first Y axis series circuit in which the first Y axis strain detection element and the third Y axis strain detection elements are connected in series, and a second Y axis series circuit in which the second Y axis strain detection element and the fourth Y axis strain detection element are connected in series are connected in parallel,
the first Y axis strain detection element and the second Y axis strain detection element being provided on a ground side,
the third Y axis strain detection element and the fourth Y axis strain detection element being provided on a supply voltage side,
the second measurement circuit including a first Y axis connection point between the first Y axis strain detection element and the third Y axis strain detection element and a second Y axis connection point between the second Y axis strain detection element and the fourth Y axis strain detection element, and wherein
the detection circuit
detects a force applied in a direction of the X axis by adding a voltage at the first X axis connection point to a voltage at the second X axis connection point, and
detects a force applied in a direction of the Y axis by adding a voltage at the first Y axis connection point to a voltage at the second Y axis connection point.

8. An input device comprising:
a shaft portion;
a plate-shaped deformation portion integrally formed with the shaft portion and orthogonal to an axial direction of the shaft portion;
a plurality of strain detection elements provided on a deformation portion; and
a detection circuit, wherein
the detection circuit includes
a first measurement circuit that includes some of the plurality of strain detection elements and detects a force applied to the shaft portion in a direction orthogonal to the axial direction, and
a second measurement circuit that includes other some of the plurality of strain detection elements and detects a force applied to the shaft portion in a direction orthogonal to the axial direction, wherein
the plurality of strain detection elements includes
a first X axis strain detection element and a second X axis strain detection element provided on a positive side of an X axis orthogonal to the axial direction,
a third X axis strain detection element and a fourth X axis strain detection element provided on a negative side of the X axis,
a first Y axis strain detection element and a second Y axis strain detection element provided on a positive side of a Y axis orthogonal to the axial direction and the X axis, and
a third Y axis strain detection element and a fourth Y axis strain detection element provided on a negative side of the Y axis, wherein
the first measurement circuit
is a bridge circuit in which a first X axis series circuit in which the first X axis strain detection element and the third X axis strain detection element are connected in series and a second X axis series circuit in which the second X axis strain detection element and the fourth X axis strain detection element are connected in series are connected in parallel,
the first measurement circuit including a first X axis connection point between the first X axis strain detection element and the third X axis strain detection element, and a second X axis connection point between the second X axis strain detection element and the fourth X axis strain detection element, wherein
the second measurement circuit
is a bridge circuit in which a first Y axis series circuit in which the first Y axis strain detection element and the third Y axis strain detection element are connected in series and a second Y axis series circuit in which the second Y axis strain detection element and the fourth Y axis strain detection element are connected in series are connected in parallel,
the second measurement circuit including a first Y axis connection point between the first Y axis strain detection element and the third Y axis strain detection element, and a second Y axis connection point between the second Y axis strain detection element and the fourth Y axis strain detection element, and wherein
the detection circuit
detects a force applied in a direction of the X axis based on a voltage between the first X axis connection point and the second X axis connection point, and
detects a force applied in a direction of the Y axis based on a voltage between the first Y axis connection point and the second Y axis connection point.

9. The input device according to claim 2, further comprising:
a flexible substrate provided on the deformation portion, wherein
the first X axis strain detection element and the second X axis strain detection element are provided adjacent to each other on one face of the flexible substrate on a positive side of an X axis with respect to the shaft portion, wherein
the third X axis strain detection element and the fourth X axis strain detection element are provided adjacent to each other on the one face of the flexible substrate on a negative side of the X axis with respect to the shaft portion, wherein
the first Y axis strain detection element and the second Y axis strain detection element are provided adjacent to each other on the one face of the flexible substrate on a positive side of a Y axis with respect to the shaft portion, and wherein
the third Y axis strain detection element and the fourth Y axis strain detection element are provided adjacent to each other on the one face of the flexible substrate on a negative side of the Y axis with respect to the shaft portion.

10. The input device according to claim 9, wherein
the first X axis strain detection element and the second X axis strain detection element are provided in parallel to each other, wherein
the third X axis strain detection element and the fourth X axis strain detection element are provided in parallel to each other, wherein
the first Y axis strain detection element and the second Y axis strain detection element are provided in parallel to each other, and wherein
the third Y axis strain detection element and the fourth Y axis strain detection element are provided in parallel to each other.

11. The input device according to claim 9, wherein
the plurality of strain detection elements is disposed radially around the shaft portion.

12. The input device according to claim 2, further comprising:
a flexible substrate provided on the deformation portion, wherein
the first X axis strain detection element is provided on one face of the flexible substrate on a positive side of an X axis with respect to the shaft portion, wherein
the second X axis strain detection element is provided at a position where the second X axis strain detection element overlaps the first X axis strain detection element on another face of the flexible substrate on a positive side of the X axis with respect to the shaft portion, wherein
the third X axis strain detection element is provided on the one face of the flexible substrate on a negative side of the X axis with respect to the shaft portion, wherein
the fourth X axis strain detection element is provided at a position where the fourth X axis strain detection element overlaps the third X axis strain detection element on the another face of the flexible substrate on a negative side of the X axis with respect to the shaft portion, wherein
the first Y axis strain detection element is provided on the one face of the flexible substrate on a positive side of a Y axis with respect to the shaft portion, wherein
the second Y axis strain detection element is provided at a position where the second Y axis strain detection element overlaps the first Y axis strain detection element on the another face of the flexible substrate on a positive side of the Y axis with respect to the shaft portion, wherein
the third Y axis strain detection element is provided on the one face of the flexible substrate on a negative side of the Y axis with respect to the shaft portion, and wherein
the fourth Y axis strain detection element is provided at a position where the fourth Y axis strain detection element overlaps the third Y axis strain detection element on the another face of the flexible substrate on a negative side of the Y axis with respect to the shaft portion.
